(19) United States
(12) Patent Application Publication
(10) Pub. No.: US 2005/0021346 A1
(43) Pub. Date: Jan. 27, 2005

(54) Method and system for creating marketplace visibility and administering freight shipments using fuzzy commodity transportation instruments

(76) Inventors: Joseph S. Nadan, Southport, CT (US); Robert C. Watson, Fort Washington, NY (US)

Correspondence Address: Dickstein Shapiro;Morin & Oshinsky, 2101 L Street NW, Washington, DC, 20037-1526, US

(21) Appl. No.: 10/344,450

(22) PCT Filed: Aug. 13, 2001
(86) PCT No.: PCT/US01/25093

Related U.S. Application Data
(60) Provisional application No. 60/225,755, filed on Aug. 13, 2000.

(51) Int. Cl. G06F 17/60

(52) U.S. Cl. 705/1

(57) ABSTRACT

A utility for creating a real-time bid-ask transportation marketplace where all relevant information may be viewed and acted upon is disclosed. See FIG. 2. Users of the present invention tender shipments and offer capacity, which are analyzed and entered into transportation instruments. Contracts obligate the shipper to make a load available and the carrier to transport the load at a given time for a given price. Shipments may be managed throughout their entire life cycle using software tools that interact with the bid-ask marketplace.

### BACKGROUND OF THE INVENTION

1. Field of the Invention

The present invention relates to a method and apparatus to arrange for and manage freight shipments. Users of the present invention tender shipments and offer capacity, which are analyzed and entered into transportation instruments. These instruments are maintained in a real-time bid-ask marketplace where all relevant information may be viewed and acted upon by users. Users are shown a listing of available counterparties to a desired transaction, and upon agreeing to a set of terms, create a contractual obligation to perform according to the terms of the instrument. Contractual obligations may also be exchanged and sold amongst users. Shipments may be managed throughout their entire life cycle using software tools that interact with the bid-ask marketplace.

2. Background of the Art

Today transportation brokers and/or third party logistics companies (“3PLs”) manage shipments on behalf of many shippers and carriers. Most transportation brokers, in a manner that is congruent to the thinking of brokers in the financial industry perhaps twenty years ago, believe that it is in their best economic interest to inhibit the visibility of transportation markets. They reason that they can maintain large spreads (i.e. their commissions) between the price that the shipper is wiling to pay and the fees paid to the carrier by not “commoditizing” transportation. Electronic trading within the financial community has indeed reduced spreads; however, the increase in sales volumes has resulted in overall increased profitability.

Today there are other different ways for freight carriers and shippers to reach agreement. Competitive electronic marketplaces employ bulletin boards, static listings of available loads and capacity, and auctions. Shippers or carriers put loads or capacity out for bid and rule based exchanges utilize uniform rules and conditions to facilitate automated matching and services. Examples include DAT (a bulletin board/negotiating service), logistics.com (an auction service), and NTE (a form of a transportation exchange).

Today's transportation agreements vary in relative “strength” from highly precise and enforceable dedicated contract carriage, to annual contracts and spot-market agreements with very loose terms and conditions. However, each suffers from drawbacks. Dedicated contract carriage and annual contracts are each respectively cumbersome to implement, and often require months of negotiation.

The $950 billion transportation logistics industry represents about 10% of U.S. GDP. It is highly fragmented with limited market visibility and largely absent or dysfunctional information technology. Most business is conducted via telephone and FAX. Both shippers and carriers require user-friendly reliable market access and real-time information to provide the quality-of-service that their customers demand. Although there are a large number of transportation web sites, none of them effectively meets the objectives of customers, shippers, and carriers. Customers need accurate market data prior to making a decision on transportation, and wish to reduce their uncertainty in the marketplace. Furthermore, carriers need the ability to increase the probability of finding a backhaul. Shippers, meanwhile, want to lock in capacity for future anticipated needs. Finally, shippers also want the cost savings associated with collaborating with other shippers without having to identify or negotiate an agreement with every other shipper.

Carriers want to predetermine their workload to minimize the cost of asset relocation. Carriers also need the ability to lower costs by offering a resource to more than one counterparty at a time; and, when the first counterparty accepts the offer, to have the system automatically remove all of the remaining offers. Shippers also need the ability to lower costs by offering a shipment to more than one counterparty at a time; and, when the first counterparty accepts the offer, to have the system automatically remove all of the remaining offers.

To achieve these and other goals could require the cooperation of a competitor. To this end, some systems offer “collaborative logistics” in which dosed communities are formed to gain market efficiency. However, these systems are not real-time, and cannot process contingent orders, and they require the cooperation of the members of the community to share proprietary information. Often, members of the community are competitors of one another and are unwilling to compromise their competitive advantages to participate in the community. Also, these systems over-emphasize virtual world models at the expense of real-world operating environments in which equipment breaks down and there are delivery delays. Further, members who participate in these dosed systems often lack the best operating and dispatch people, because these people have migrated to better paying jobs with carrier or 3PLs for whom transportation is the core competency.

Most other systems cover spot markets that represent only 20% of the for-hire truckload transportation market. Contract carriage represents about 80% of the for-hire truckload transportation market; thus, most other systems are aimed at the smaller market segment. Also, most other systems do not allow the hedging of price and availability risk by participating in forward or series purchases. Such systems thus entirely lack risk management.

Third party logistics providers (3PLs) work on behalf of their customers i.e. shippers to both improve the reliability of transportation and minimize its cost. They do this by recommending shipping policy, selecting carriers to transport loads, and managing the entire life cycle of shipments. Unlike the financial industry in which perhaps more than 99.9% of all trades “clear” without incident, in transportation perhaps only 95% of all shipments are transported without the intervention of a “transportation expert” to remedy problems. When a transportation problem occurs, the 3PL provides a service to their customer and alleviates the problem.

However, many other systems (some even proudly) do not allow the participation of brokers or 3PL companies to enable their users to avoid having to pay brokerage fees that are typically in the range of 8% to 12% of the total cost of transportation. The brokerage fees, which are proclaimed by these sites to be “recoverable” by using their system, are currently paid to the broker or 3PL who provide transportation management services using, for the most, part the inefficient technology of the “FAX and telephone” age. The cost of these services may be reduced considerably by using more advanced technology and competition. It is important to remember that many of these intermediaries, in addition to matching a shipper and carrier, provide valuable transportation management services and have and will try to protect their well-established customer relationships. Thus, these systems disintermediate existing players. As a result, they only penetrate a small piece of a well-entrenched market.

Shippers and carriers need to improve their profitability by reducing the number of empty backhauls, delayed or lost shipments and warehouse bottlenecks, and the amount of effort required to manage core carrier relationships efficiently.

Typically, when transportation managers have goods “ready-to-go” they send faxes or make multiple calls to their brokers at their 3PLs 100, as shown in FIG. 1. This process specifies the shipment and usually states what the shipper is willing to pay. The transportation manager is unable to “see the market”; i.e. they do not know the current spot price that other shippers are willing to pay or that carriers are willing to accept, or the availability of trucks. The brokers then send faxes or make multiple calls to dispatchers 101 at their carriers to check the price and availability of transportation to fill their need. The transportation manager does not participate in this process. After the shipment is booked, the broker must convey this information back to the shipper 103 and verify that the carrier has adequate insurance in force. This slow and people intensive process enables a broker to manage only 5 to 10 shipments a day.

The above unsophisticated approach results from the fact that the current transportation industry contracting process was created in the “fax and telephone” age. Such a contracting process is antiquated, particularly when compared to the prevailing practices in the financial industry in which all participants are able to electronically view real-time markets and immediately execute orders when they see opportunities. Shippers and carriers cannot effectively manage risk using current transportation practices—most annual contracts are in reality just rate agreements that do not have firm commitments of shipments or trucks and only represent rates and other possible terms and conditions.

### SUMMARY OF THE INVENTION

In one aspect, the present invention provides a method of brokering transportation transactions, including receiving into a staging area a plurality of dissimilar bids for shipping goods, receiving into said staging area a plurality of dissimilar offers for transporting goods, sorting and aggregating said shipping bids into a set of first fuzzy commodities, sorting and aggregating said carrier offers into a set of second fuzzy commodities, selecting matching sets of said first and second commodities in said staging area to create transportation instruments; and creating underlying contracts to support the trading of the transportation instruments.

In another aspect, the invention provides a computer system for brokering a plurality of freight-shipments and carrier capacity, including marketplace means for establishing a bid-ask (offer) marketplace including shipper bids and carrier offers, wherein the bids and offers are measured by mode, market, and lane and optionally accessorial services.

In yet another aspect, the invention provides a computer system for trading transportation futures, including receiving into a staging area a plurality of dissimilar bids for shipping goods, receiving into the staging area a plurality of dissimilar offers for transporting goods, sorting the shipping bids into a set of first futures, sorting and aggregating the carrier offers into a set of second futures, selecting matching sets of the first and second futures in the staging area to create a bid-ask marketplace for transportation future instruments, and creating underlying contracts to support the trading of the transportation future instruments.

In yet another aspect, the invention provides a computer system for trading transportation options on futures, including receiving into a staging area a plurality of dissimilar bids for options on futures for shipping goods, receiving into the staging area a plurality of dissimilar offers on options on futures for transporting goods, sorting the shipping bids into a set of first options on futures, sorting and aggregating the carrier offers into a set of second options on futures, selecting matching sets of the first and second options on futures in the staging area to create a bid-ask marketplace for transportation option on future instruments, creating underlying contracts to support the trading of the option on futures transportation instruments, and bi-directional communication links coupled the computer system to the futures and options computer systems to create price consistency and to facilitate inter-market trading to manage risk taken in a position resulting from a trade in either market.

In yet another aspect, the invention provides a method of calculating a standardized transportation line haul rate per mile, including receiving into a staging area transportation data for a shipment, calculating standardized route miles from the zip codes of all stops in transit including origin and final destination and allowable practical routes for the type of cargo transported, calculating the line haul price from the total price less standardized charges for provided accessorials; and calculating the standardized line haul rate per mile by dividing the line haul price by the standardized route miles.

In yet another aspect, the invention provides a computer system for calculating historical market data on transportation, including a means for receiving into a staging area a plurality of completed shipment transportation data, and a software program to calculate the standardized line haul rate per mile for each completed shipment.

In yet another aspect, the invention provides a method of brokering transportation transactions, including receiving into a staging area a plurality of dissimilar bids for shipping goods, receiving into the staging area a plurality of dissimilar offers for transporting goods, sorting and aggregating the shipping bids into a set of first fuzzy commodities, sorting and aggregating the carrier offers into a set of second fuzzy commodities, selecting matching sets of the first and second fuzzy commodities in the staging area to create transportation instruments, and creating underlying contracts to support the trading of the transportation instruments.

### BRIEF DESCRIPTION OF THE DRAWINGS

The foregoing and other features and advantages of the invention will become more apparent from the detailed description of the exemplary embodiments of the invention given below with reference to the accompanying drawings.

FIG. 1 shows the “FAX and telephone” implementation of conventional transportation order processing.

FIG. 2 shows the online computer system for creating transportation instruments of the present invention.

FIG. 3 graphically illustrates the meaning of the “lane miles” of the present invention.

FIG. 4 graphically illustrates the meaning of the “route miles” of the present invention, both with and without a Stop In Transit.

FIG. 5 shows a summary of contingent order processing of the present invention for the case where the probability of finding a backhaul to a single destination is 10%.

FIG. 6 shows the type of roles various users of the present invention fulfills.

FIG. 7 shows the basic components of a link in a graphical navigation bar of the present invention, including a title bar and a content area.

FIG. 8 illustrates a fill page TrantisLink graphical navigation bar containing six links.

FIG. 9 shows the TrantisLink main screen and its five logical areas.

FIG. 10 shows an expanded view of a TrantisLink watchlist.

FIG. 11 shows an expanded view of the market details behind a transportation instrument in a TrantisLink watchlist.

FIG. 12 shows the use of anonymous ratings in the market details.

FIG. 13 shows an open order summary list of the present invention.

FIG. 14 shows how an open order is be modified within the present invention.

FIG. 15 shows a list of incomplete bookings of the present invention.

FIG. 16 shows the tracing and tracking booking status of the present invention.

FIG. 17 shows the tracking and tracing booking details of the present invention.

FIG. 18 shows tracking and tracing booking problems of the present invention.

FIG. 19 shows tracking and tracing report a problem of the present invention.

FIG. 20 shows tracking and tracing problem submitted of the present invention.

FIG. 21 shows an alert list of the present invention.

FIG. 22 shows find a truck data entry of the present invention.

FIG. 23 shows find a shipment data entry of the present invention.

FIG. 24 shows tendering a shipment data entry of the present invention.

FIG. 25 shows offering a truck data entry of the present invention.

FIG. 26 shows contingent offer of a truck of the present invention.

FIG. 27 shows completed shipments data entry of the present invention.

FIG. 28 shows lane history data request and response of the present invention.

FIG. 29 shows user preferences of the present invention.

FIG. 30 shows network administration data entry of the present invention.

FIG. 31 shows company administration data entry of the present invention.

FIG. 32 shows single company administration data entry of the present invention.

FIG. 33 shows the display of trading exposures of the present invention.

FIG. 34 illustrates using series and forward contracts to hedge price and availability risks of the present invention.

FIG. 35 illustrates a private network utilizing the present invention run by a sponsor (super shipper or 3PL).

FIG. 36 illustrates two private networks run by two different sponsors.

FIG. 37 shows how some distressed loads on one network is matched on another of the networks shown in FIG. 36 within the present invention.

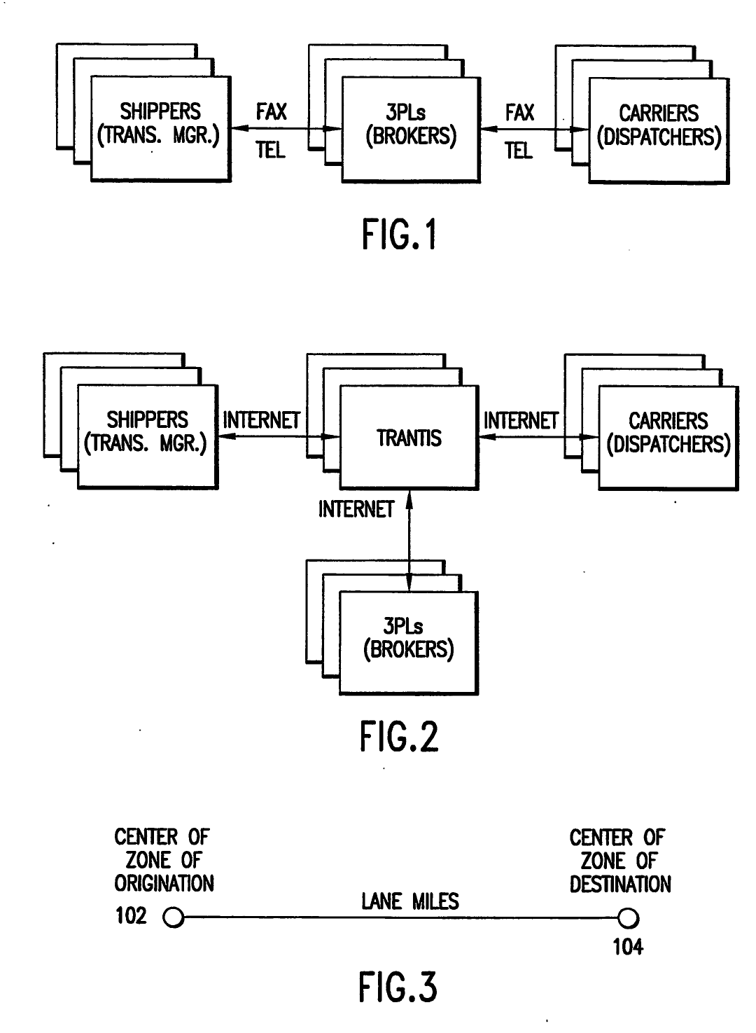

### DETAILED DESCRIPTION OF THE PREFERRED EMBODIMENTS

### Overview

Traditionally, technological change in the transportation industry has been in a top-down fashion from the largest companies to smallest companies. The Internet has turned this upside-down. Now, more technologically agile companies with a customer focus and strong backing drive the market. The philosophy behind the present invention is that all parties in the transaction process must benefit for the model to operate effectively; unlike companies that disintermediate the industry, the present invention has developed various solutions that allow customers to become more profitable.

The present invention hereafter referred to as TrantisLink^{SM}, approaches the transportation logistics market using a unique business model that extends the financial commodity market model to include the commercial realities of transportation. The underlying premise is that transportation is managed as a type of “fizzy commodity” which is defined as a physical good having a large number of attributes that is standardized or classified using the TrantisLink methodology described hereinafter such that it is the object of commercial transactions. Consider a typical commodity, e.g. 99.99% gold, which is rigorously defined and therefore traded as a commodity. In transportation, all shipments are not created equal; they have different cargos, different pickup and delivery locations and dates, and different required accessorial services. The large number of different possible shipments would normally preclude their being traded as a rigorously defined commodity. However, within commercially reasonable limits, trucks and shipments are fungible; e.g. one dry van may be substituted for another, and one load may be substituted for another. Hence using the TrantisLink business methodology, the line-haul parts of multiple shipments are separated out, sorted and aggregated into a fuzzy commodity bid-ask marketplace.

TrantisLink creates a broader coverage of markets and executable real-time data through “transportation instruments” backed by binding contracts between the shipper and carrier that obligate the shipper to make a load available and the carrier to transport the load at a given time for an agreed-upon price. These transportation instruments support the aggregation of the line haul parts of shipments while preserving the essential differences in each shipment. Hence participants may trade the line haul and mode with other similar line hauls and modes. For example, when a transportation manager has goods “ready-to-go” that manager uses TrantisLink to first access and then evaluate the current market condition. The manager views the current price and availability of transportation capacity in real-time and then determine whether they want to delay shipping one day to save perhaps 15 to 20 cents/mile.

The total 1999 market for motor carrier transportation in the United States was $450 billion. For-hire truckload transportation was $110 billion. The average number of for-hire truckload shipments per day in the United States is about 500,000. Of these, 100,000 are in the spot-market, and 400,000 are in the annual and dedicated contract marketplaces.

Also, the trucking industry in the U.S. is highly fragmented. According to Armstrong & Associates, the 50 largest carriers combined have $18 billion in revenue, which is less than 20% of the total market. The largest company, Schneider National, has annual revenue of slightly more than $3 billion. There are over 300,000 trucking companies; only 20,000 carriers have nine or more trucks; the average trucking company has only seven trucks.

### TrantisLink and Third Party Logistics Providers (3PLs)

To overcome the fragmentation referred to above, TrantisLink provides online computer support system 105 to accomplish all of the above functionalities using the Internet as a communication medium, as shown in FIG. 2. The TrantisLink is deployed in a hardware platform such as an Internet server system, but can also be deployed within a LAN/WAN environment. In any case, the following detailed description will focus more on the software implementation of the present invention. TrantisLink also allows all of the 3PLs to set and collect their own management fees in a competitive environment subject to a minimum fee set by TrantisLink rules that may from time to time be changed. Additionally, whenever a problem occurs, the managing 3PL will use the provided software tools to workout the problem on behalf of their damaged customer by finding an appropriate solution in the marketplace.

Additionally, virtual 3PLs are those 3PLs that actively manage transportation for shippers via web sites. While some have spot-market exchanges, their focus is on managing shippers' transportation requirements; thus the TrantisLink marketplace is just a part of their model. It will be advantageous for these companies to participate in TrantisLink forward and series marketplaces. Speculators can trade transportation contracts based on transportation instruments to gain profit without the intention of actually transporting cargo. They are also likely to participate in the forward and series marketplaces.

Managing 3PLs will also provide advisory services and liquidity to TrantisLink and in return receive:
(i) Assignment of new customers when shippers who do not have a prior existing relationship with a 3PL first join the market;
(ii) The right to use the TrantisLink system as a “private” system handling only their business transactions; and
(iii) Equity in Trantis in proportion to their provision of transaction volume and participation in the TrantisLink Advisory Board.

Thus, TrantisLink embraces rather than disintermediates third party logistics providers. As shown, the Managing 3PLs actively participate in this B2B electronic transportation market. Their presence increases market confidence in the TrantisLink system. Additionally, TrantisLink may be used by other 3PLs that wish to offer their customers' shipments and carrier capacity to a wider range of counterparties than is currently accessible to them. Although TrantisLink will not assign this group of 3PLs new customers to manage, their participation will increase the liquidity of the market.

### Transportation Instruments

TrantisLink creates a standardized marketplace because it creates and uses fungible transportation instruments (i.e. one shipment may be substituted for another and one truck may be substituted for another in fulfilling an obligation) to aggregate shipping demand and carrier capacity. Transportation instruments are based on underlying contracts between a shipper and a carrier that obligate the shipper to make a load available and the carrier to transport the load to its destination. To create transportation instruments, individual shipments and trucks are separated out, sorted and aggregated without including the specific details which are necessary for delivery.

The standardized transportation instruments are characterized by mode (i.e. type of transport), market (e.g. spot, forward, or series of pickups and their corresponding dates), and lane (i.e. zone of origin and destination). TrantisLink aggregates multiple shipments sharing common elements from among these parameters and presents the best market prices and available shipments and capacity to the marketplace. This standardization will dramatically change the market by permitting shippers and carriers to see the current market and to hedge against future price and availability fluctuations. In addition, TrantisLink rules provide for enforceable underlying contracts to support future performance. These changes replace the vagaries of current contract market practices.

As stated, transportation instruments are defined by mode, market, and lane, further described below. Additionally, each transportation instrument may have a bid and ask price and an amount available at those prices.

Mode

TrantisLink supports many different modes of transportation. Available modes include but are not necessarily limited to dry van, refrigerated/temperature controlled, flatbed/specialized, liquid bulk, dry bulk, and intermodal (combination). Offered shipments may be contingently tendered simultaneously to more than one mode.

Market

Markets are described by the intended date(s) of execution. The system currently supports four types of markets; i.e. spot, shorthaul, forward, and series, and is extendible to support other types of derivative markets (e.g. futures, options, etc.).

A spot market is created when a load is tendered or a truck is offered for pickup on a single predetermined day usually in the near future (e.g. today, tomorrow, day after). For example; a load tendered for next Monday is a spot market. A pickup on the last day of this month is a spot market. A pickup scheduled for the first of the month four months ahead is also a (not likely to occur) spot market.

A shorthaul market is created when a load is tendered or a truck is offered for pickup and delivery on a single predetermined day usually in the near future (e.g. today, tomorrow, day after). For example, a load tendered for pickup and delivery next Monday is a shorthaul market. A pickup and delivery on the last day of this month is a shorthaul market. A pickup and delivery scheduled for the first of the month four months ahead is also a (not likely to occur) shorthaul market.

A forward market is created when a load is tendered or a truck is offered for a single pickup within a single predetermined time period other than a day (e.g. week or month). For example, a single pickup scheduled for this month, a pickup during the third week in July, and another one for anytime in the month of August are all forward markets.

A series market is created when loads are tendered or trucks are offered for multiple pickups on more than one predetermined day, week, or month. The most common types of series markets are intended to compete with annual contracts. For example, pickups scheduled for every Monday during the next month, the first week of each of the next six months, or one day (to be agreed upon ahead of time) of each week for the third quarter are each series markets.

Forward and series markets specified for weeks or months are not directly deliverable and must be either converted into a spot or shorthaul market prior to delivery or cash settled. According to the applicable TrantisLink rules, the shipper selects the method for execution and related pickup and delivery dates and must give adequate prior notice (e.g. at least three days for forward contracts). The system also supports the possibility of pickup day-of-the-week price modifications.

Lanes

The entire United States is divided into a number of zones (i.e. service areas or regions). A zone is defined by a combination of states, cities, and/or zip codes. A zone may have any name; for example, the “Chicago” zone is defined by a series of zip codes that for commercial reasons includes the city of Milwaukee that is about 90 miles from Chicago.

A lane is completely defined by a zone of origination and zone of destination. For example, the Chicago to LA lane has Chicago as its zone of origination and LA as its zone of destination.

The number of “lane miles” in a lane is specified as the number of “standard” highway miles from the “center” of the zone of origination 102 to the “center” of the zone of destination 104, as shown in FIG. 3. An extended price for a basic shipment is found by multiplying the rate per mile by the number of lane miles. Lane miles are frequently used in historical comparisons.

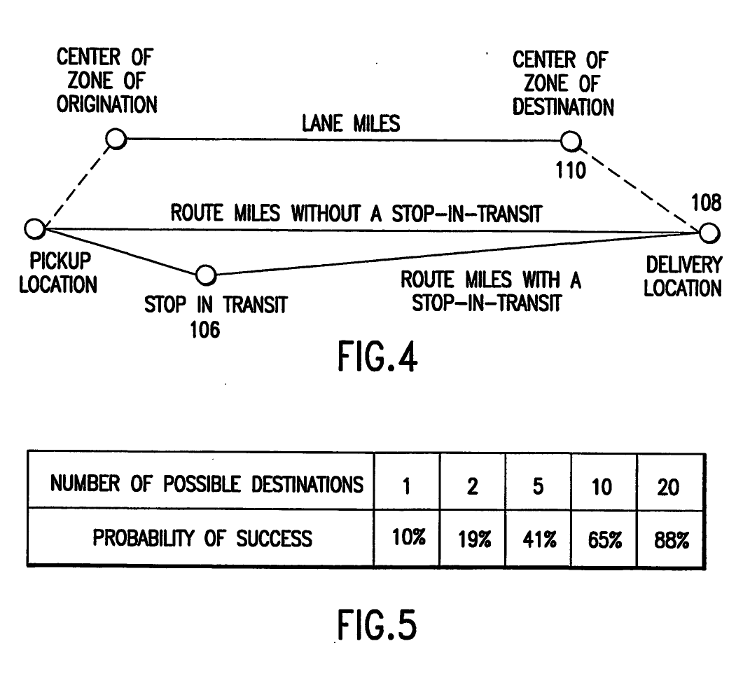

The number of “route miles” for a shipment is specified as the number of “standard” highway miles from the pickup location to the destination location. This is illustrated in FIG. 4 both with and without a Stop In Transit 106. Note that route miles may be larger or smaller than lane miles; however, on longer trips they should be almost the same.

Out-of-route miles are the difference between the route miles without a stop-in-transit and the route miles with a stop-in-transit. TrantisLink may limit the maximum allowable number of stops-in-transit and/or out-of-route miles. According to the rules of TrantisLink, accessorial route miles may be added when the final delivery location 108 is remotely located from the center of the zone of destination 110.

### Rates, Prices, and Quantities

The rates and prices quoted in a transportation instrument are usually expressed in net amount available to a carrier; i.e. the quoted extended price is the total price paid by the shipper less the management fee taken by the 3PL. The following example shows how a shipment may be tendered as either a gross rate per mile or a gross price:

| | |
|---|---|
| Lane miles: | 900 |
| 3PL fee: | $125 (set by the 3PL managing the shipment) |

Proceed in One of Two Columns

| | (Method 1) | (Method 2) |
|---|---|---|
| Enter: | Gross Price | Gross Rate per Mile |
| | $1,035 | $1.15 |
| Calculate: | Net Price to Carrier | Extended Gross Price |
| | $910 | $1,035 |
| | (=1,035 − 125) | (=900 × 1.15) |
| Calculate: | Net Rate Per Mile to Carrier | Net Price to Carrier |
| | $1.01 | $910 |
| | (=910/900) | (=1035 − 125) |

In either case the market would be displayed as paying $ 1.01/route mile and a total extended price of $ 910 to the carrier.

The number of trucks required or available are expressed as integer multiples of ¼ of a truck. The most frequent size used is a single truck. However, multiple truck shipments may be offered or accepted within a single entry. The less than a truck load (“LTL”) minimum amount of 0.25TL may be used to support cross company load consolidation.

The following example illustrates a transportation instrument:

| LANE | MODE | MARKET | RATE | QTY | TOT | LAST | VOL |
|---|---|---|---|---|---|---|---|
| LA-CHI | VAN | 4/11 | 1.10- | 5 × 7 | 8 × 12 | 1.15 | 27 |
| | | | 1.15 | | | | |

This instrument represents the aggregate supply and demand of all transportation in dry vans from the LA zone to the Chicago zone on April 11th. The highest basic bid price for shipments is $1.10 per mile and five trucks are available at that rate. The lowest basic ask price for trucks is $1.15 per mile and seven trucks are available at that rate. The total number of shipments bid is eight, which means that three (8-5) are tendered at rates less than $1.10 per mile. The total number of trucks offered in 12, which means that five (12-7) are available at rates more than $1.15 per mile. The last trade (i.e. booking) was at a rate of $1.15 per mile and 27 dry van shipments have been booked for LA to Chicago on this day.

Since there are 2,000 lane miles between the center of the LA zone and the center of the Chicago zone, the most that a shipper is currently willing to pay for transport between the two centers is a basic fee of $2,200 a truckload; similarly the least a carrier is asking for is a basic fee of $2,300 per truckload. The above example is for illustrative purposes only, and it should be noted that it is necessary to supply additional information including actual route miles to determine the total price for a specific shipment prior to its transport.

TrantisLink is reliable because 3PLs stand behind booked shipments from inception through final delivery. Even though the system is highly automated to support the activities of its users, TrantisLink relies upon 3PL staff to apply their knowledge of the transportation industry to manage operational problems that frequently occur on a day-to-day basis in transportation. The TrantisLink marketplace and software tools greatly facilitate this process.

In the context of TrantisLink, a 3PL or one of its customers manages each shipment. The act of management involves an obligation on the part of the 3PL to use commercially reasonable efforts to ensure that the contracted terms of the shipment are met. For example, in the event that a truck with a load breaks down on the road, the 3PL (or carrier) must attempt to locate another truck to complete the shipment under the agreed terms.

TrantisLink functions in real-time to support optimization and collaborative logistics on behalf of both shippers and carriers. Currently, many 3PLs have negotiated and work under fixed rate annual contracts with both shippers and carriers. Most of these contracts do not include an enforceable minimum number of shipments (or trucks) over their terms and require 3PLs to satisfy shipper demand in the spot market. Hence, 3PLs need to maintain the cooperation of carriers to make spot capacity available whenever the demand for trucks is high and the spot rate exceeds the negotiated and agreed upon rate in the annual contract. This system of maintaining “relationships” or informal “favors” is often supported by either overpayment of the annual rate and/or indirect payments of another nature.

TrantisLink uses its real-time functionality to support contingent order processing of four types, time period, multi-mode, multi-destination, and strategy.

Shippers may be willing to tender a load for a limited period of time. Unless otherwise specified, all orders are considered Good-Till-Canceled. Shipments tendered for a limited time period are automatically removed by the TrantisLink system when the time period is reached.

Shippers may be willing to use more than one mode of transportation to transport a load. A shipment may be tendered at one rate for expedited two-day delivery by truck, a lower rate for normal three-day delivery by truck, or at a still lower rate for six-day delivery by intermodal. All of these bids are simultaneously entered into the real-time market. When any one of these loads is booked, the TrantisLink system immediately removes all of the remaining contingent bids for the shipment.

Similarly, carriers may desire to have a truck at a location carry a load to one of many different destinations. All of these offers are simultaneously entered into the real-time market. When any one of these truck offers is booked, the TrantisLink system immediately removes all of the remaining contingent offers for the truck.

The benefit of real-time contingent order processing may be extended to include executing an operational strategy. Consider the case of a shipper with a large number of distribution centers stocking a large number of stores using dedicated assets (e.g. trucks on annual lease). Most head-haul runs are efficiently scheduled and the trucks are substantially filled; most backhauls are not efficiently filled, many are even empty. The shipper may increase their operational efficiency by attempting to get a backhaul shipment from another shipper in the vicinity of the store where the truck is making a delivery. The probability of finding a backhaul to a single destination is low; for example perhaps 10%. As shown in FIG. 5, the probability of successfully finding a backhaul increases as the number of possible return destinations increases. However, to maintain proper operation the shipper must ensure that each of their distribution centers has a minimum number of trucks available each day. TrantisLink is capable of executing this operational strategy, specifically, removing all contingent truck offers that would be capable of depleting the number of trucks returning to a given distribution center below its minimum allowable value.

The TrantisLink system uses a minimum unit of transportation equal to ¼ of a truck to support partial load commerce or cross-shipper load consolidation. The following example illustrates partial load commerce: A driver picks up a shipment and notices that the truck is only about ⅔rds full. Just before departing the dock he logs in and informs TrantisLink that he has accepted the load and offers a ¼ truck for all possible lanes with pickups and destinations along the route that would allow him to maintain his original schedule. The driver also defines the type of load to ensure that any subsequent partial load(s) will be compatible with the initial load on the truck. The system notifies the driver of all currently available partial loads that he may book. The driver first ensures that the subsequent partial load will be compatible with the initial load on the truck and then accepts one of these loads and modifies his route to accommodate the additional freight. When there are no current “matches” the system displays the passive offer of the ¼ truck such that another shipper might manually accept it. The driver is electronically notified of any acceptance of his offer and must verify its compatibility with the initial load.

The system will support multi-trip end-to-end optimization by allowing a carrier to enter different rates for each leg of a trip and an average rate for the entire trip. For example, a carrier offers to go one way for $1.35 per mile and $1.15 per mile for an end-to-end round trip. The system will initially enter $1.35 for both the front and back haul legs. When one of these legs is booked, the system will immediately change the rate of the unfilled leg to $0.95.

TrantisLink also supports the booking of short-haul and/or drayage shipments at flat charges according to the TrantisLink rules that may from time to time be changed. A transportation instrument is defined for each service area in which any load may be transported from any pickup location within the service area at a fixed price that is determined by the market. However, it is to be emphasized that shorthaul or drayage imply that:
The fixed price depends on the anticipated amount of time to complete the obligation and not on the actual number of route miles; and
Accessorial charges may be added to the fixed price to determine the total price paid to the carrier.

### Proper Disposition (Completion) of Transportation Contracts

Transportation contracts are completed once all of their contractual obligations have been met. They may be transferred to another suitable counterparty; i.e. the obligation may at any commercially reasonable time prior to a scheduled pickup be transferred at its then current market price to another suitable TrantisLink participant. This process requires the current owner of one part of the obligation to find a wiling counterparty to accept the transfer for a price. Potential counterparties may want to apply their own subjective ratings before accepting the transfer. Contracts may also be cancelled subject to an agreed upon penalty.

Completion implies that an individual shipment(s), characterized by additional shipment details unique to each shipment, has been delivered. Shipment details include (1) precise pickup and destination locations, (2) number and location of stops-in-transit, (3) whether driver loading and/or unloading are required, etc., which modify the basic description of the transportation instrument within predefined limits according to the TrantisLink rules. Failure implies that transportation of a shipment does not take place. The transportation contract matures and the party causing the failure is responsible for paying a financial penalty according to the rules of the exchange. The managing 3PL is expected to mitigate the cost of any damages.

### Types of TrantisLink Participants

This section presents the types of businesses that participate in TrantisLink, the roles that they play, how their performance is rated by the TrantisLink system, and their insurance coverage. These include 3PLs, managing 3PLs, insurance companies and agents, shippers; super-shippers; carriers, mega-carriers, truckstop operators, ancillary service companies, factor receivable banks, insurance companies and agents, and financial institutions.

Managing 3PLs are 3PLs that have agreed to accept additional assigned TrantisLink responsibilities and benefits. Shippers are suppliers of a small amount of transportation demand. Super-shippers are suppliers of significant transportation demand. It is very likely that super-shippers will require a high-speed interface into their own internal computer systems. Carriers are suppliers of a small amount of transportation capacity. Mega-carriers are suppliers of significant transportation capacity. It is very likely that mega-carriers will require a high-speed interface into their own internal computer systems. Truckstop operators provide roadside TrantisLink access for carriers. Ancillary service companies are providers of various services to the transportation industry. Factor receivable banks are providers of financial services to shippers and carriers. Insurance companies and agents are providers of cargo, liability, and other types of insurance coverage and information pertinent to the transportation industry. Financial institutions are consumers of transportation information. These institutions may, under contract with TrantisLink, redistribute that information.

### Roles of TrantisLink Participants

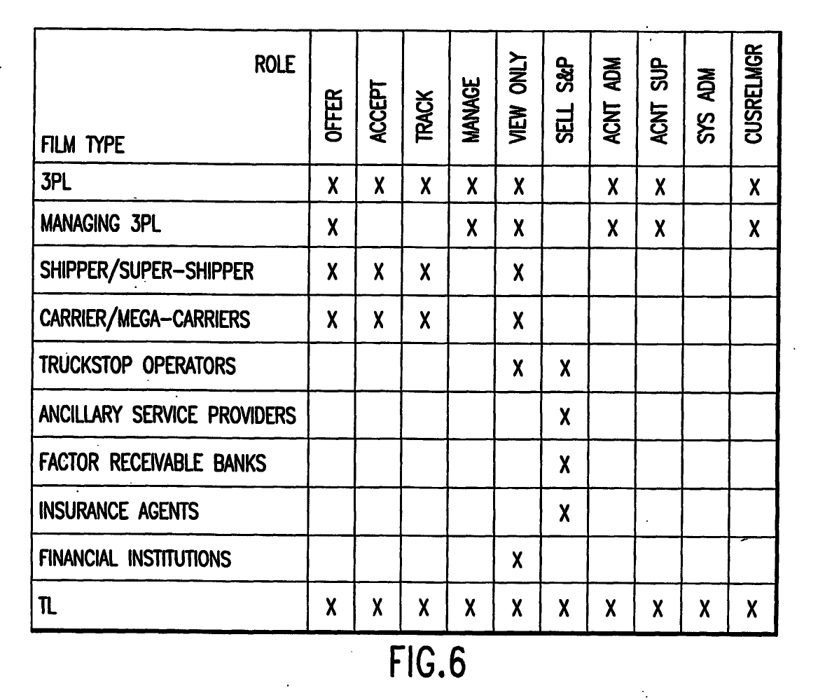

Each firm type may participate in TrantisLink activities as described as FIG. 6. The definitions of each type of role are supplied below.

Offer: place loads or transportation capacity into the market. A data entry task that specifies only the basic or the complete specification of a load or available truck.

Accept: book transportation capacity or loads that are in the market.

Track and Trace: monitor the entire life cycle of shipments. Remotely located users follow the shipment from booking through completion.

Manage Shipments: monitor and control the entire life cycle of shipments.

View Only: view current prices and capacity in the real-time market or historical prices and capacity over time.

Sell Ancillary Products and Services: provide products and services to participants.

Account administration: create sub-accounts and users, assign rights, maintain insurance records, and set credit limits.

Account supervision: monitor and/or supervise orders.

System administration: monitor and maintain the proper operation of the system.

Customer Relationship Management: assist customers in their use of TrantisLink's ancillary information

### Ratings and Information

TrantisLink supports several types of performance ratings and information on insurance coverage. These include surveys of shipper perception of the performance of carriers, individual perception of the performance of counterparties, objective performance of shippers, carriers, and 3PLs as measured by the TrantisLink system, and private transaction flags.

Data from http://www.carrierrankings.com is used to enable shippers to select transportation alternatives for their company. Shippers contribute confidential surveys on eight rating criteria (i.e. overall performance, operating personnel, administration, information technology, equipment, on-time performance, cost, and safety and compliance) for thousands of carriers. The aggregated ratings of all surveys are used to create a ranking and letter grade for each carrier within each mode. Shippers may apply their own “importance” weights to each rating criterion and calculate their own custom rankings.

Additionally, each shipper, carrier and 3PL is able to assign their own letter grades to individual counterparties. They may rate a preferred counterparty as “A”, a good provider as “B”, and someone they do not want to use as “F”. These custom created grades are then displayed to the user for their private use prior to the complete identification of the counterparty in a transaction.

Furthermore, the TrantisLink system monitors the actions of all parties to a transaction and rates their objective on-line performance by logging events such as availability and timely arrival of booked loads and trucks, prompt entry of tracking information, cargo damage claims, payment of fees, etc.

Finally, one or more loads and/or trucks are transferred between the public network and private network of a firm by using a form of “rating” to set/unset a private transaction flag.

The TrantisLink system connects with insurance providers to obtain and then display information on the current in-force coverage held by shippers and carriers.

### Extending a Basic Transportation Contract to Support Transport

Additional information must be added to a basic transportation contract to make it possible to transport a load and calculate the total price of the shipment. The following example illustrates some of the information that must be added to qualify a basic transportation contract for delivery:

Lane: LA to Chicago

| | | |
|---|---|---|
| Lane miles: | 2,000 | |
| Basic rate: | $1.15 per mile | |
| Extended basic price: | $2,300 | |
| Pickup: | | |
| Location: | Address in LA: | ZIP-90021 |
| Accessorial: | Loading Fee: | NC |
| Stop in Transit: | | |
| Location: | Address in Denver: | |
| Accessorial: | Stop Fee: | $50 |
| Final Destination: | | |
| Location: | Address in Chicago: | ZIP-60601 |
| Accessorial: | Unloading Fee: | $100 |

Calculation of Total Price:
Total Price = (Rate Per Mile × Route Miles) + Accessorail Charges

| | | |
|---|---|---|
| Route miles: | 2,315 | |
| Mileage Fee: | $1.15 × 2,315 | $2,662.25 |
| Total Accessorial Fees: | | $150.00 |
| Total Price: | | $2,812.25 |
| Average Rate/Route | | |
| Mile: | | |
| Payment to Carrier | | |
| Total Price: | $2,812.25 | |
| Transaction Fee to | $10.00 | (set by TrantisLink) |
| TrantisLink: | | (note: volume |
| | | discounts may |
| | | apply) |
| Net Amount to Carrier: | $2,802.25 | |
| Average Rate/Route | $1.2105 | |
| Mile: | | |

### Shipment States

Shipments are monitored and controlled throughout their entire life cycle from offering through transit and delivery to payment. TrantisLink processes user input to implement this functionality and assigns a revised current state (note: in this context, “state” means status and not geographical location) to each shipment as it is being transported.

A shipment will be in one and only one of the following ten states:

1) Open

A shipment is “open” when it is in the market and not yet accepted.

2) Cancelled

A shipment is “cancelled” when it is in the market and the user who originally placed the shipment (or their supervisor) takes it out of the market without the possibility of later re-entry. A cancelled shipment may not be accepted.

3) Subject

A shipment is “subject” when it is in the market and the user who originally placed the shipment (or their supervisor) takes it out of the market and saves it for possible later re-entry. A subject shipment may not be accepted. The user who originally placed the shipment may cancel a subject shipment.

4) Booked—Not Confirmed

A shipment is “booked—not confirmed” when a party (i.e. the “active” party) has accepted it, and the (passive) counterparties have not yet been notified. A shipment can be accepted and a passive party may not yet have been notified if they are offline. TrantisLink system will attempt to notify the passive side using alternative methods specified in the counterparty user profile (e.g. paging, fax, automated voice mail, etc.). TrantisLink may (using commercially acceptable rules) set a commercially reasonable time limit that a shipment may remain in the booked—not confirmed status.

5) Booked—Confirmed

A shipment is “booked—confirmed” when the active party has accepted it and all of the passive parties have been notified.

6) In Transit

A shipment is “in transit” after the shipment has been loaded at the pickup location and the carrier has departed the loading dock.

7) Delivered

A shipment is “delivered” after the shipment has been unloaded at the destination location and a delivery receipt has been given.

8) Completed

A shipment is “completed” after the shipment has been received and the carrier has been paid. The TrantisLink system supports computerized monitoring of payments whether or not payment is effected through TrantisLink.

9) Claim-in-Progress

A completed shipment may at some time in the future have a damage claim. TrantisLink system supports computerized monitoring of damage claims.

10) Failed

A 3PL or the original user who placed part of a shipment may apply TrantisLink, rules to fail a shipment from any of the above states prior to it being in transit. For example, a shipper may have a shipment in the booked—confirmed status and realize that it no longer requires transportation. This may be due to cargo not ready, consignee unable to accept shipment, etc. The shipper (or their 3PL) fails the shipment. TrantisLink rules are applied to all parties to the shipment who have an incentive through their respective performance ratings to mitigate the effects of any failure.

A shipment state may be modified according to TrantisLink rules. Open shipments may be cancelled or made subject without obligation before they are matched. Subject shipments may be resubmitted or modified and then resubmitted or cancelled. Users may modify (or cancel) shipments in a “booked—not confirmed” or “booked—confirmed” status. These modifications may incur a financial penalty and require effort by the Managing 3PL to mitigate any damages. For example, a shipper accepts vans from three different carriers. Two of the carriers are online and their notification of the shipment is logged by the system. The third carrier is offline. The shipper then cancels the shipment. A managing 3PL will workout this cancellation according to TrantisLink rules. This could mean finding alternative shipments that are acceptable to the carriers and/or having the shipper pay a financial penalty to the carriers.

The TrantisLink system supports automatic notification of alerts and events via messages to the user conveyed by a variety of technologies including wireless, voice telephone, and web. For example, an owner operator may be notified by telephone that he has received a shipment booking, or affected parties will be notified of a change in shipment status.

### The TrantisLink Graphical User Interface

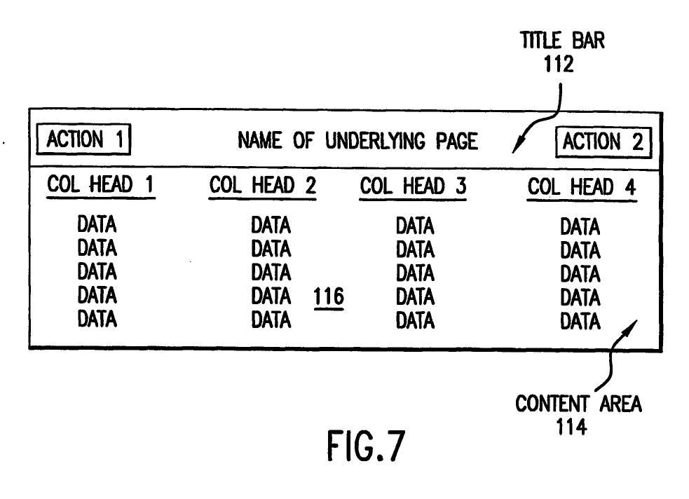

TrantisLink information displays are intended to present information in a timely and useful manner with an absolute minimum of required user interaction. This is accomplished through the use of a “graphical navigation bar” and “prioritized scheduled push” of information from the server to the client, as shown in FIG. 7.

A standard navigation bar consists of a number of links displayed in text form. The basic components of a link in a graphical navigation bar include a title bar 112 and a content area 114, as shown in FIG. 7. These are usually presented as a vertical list on the left side of the page or a horizontal list at either the top or bottom of the page. This methodology implies that the user understands the functionality underlying the URL of each link from its text. Some designers prefer to replace some of the text links with buttons that contain a small graphic or picture to hint at the underlying functionality of the link.

A graphical navigation bar extends this paradigm still further by displaying a small amount of the underlying information behind each link. While this uses more area on the viewed page, it gives visual feedback that a request has been properly processed and frequently obviates the need to click through to the link. The basic components of a link in a graphical navigation bar include a title bar 112 and a content area 114, as shown in FIG. 7.

The title bar 112 has a title and may have one or more action buttons. Clicking an action button causes the action to occur. This may change the data in the current link, change the data in a different link, or may cause the display of new links or pages. For example, clicking on the button labeled “action 1” closes the link while clicking on the button labeled “action 2” replaces the current page with a new page with or without a graphical navigation bar.

The content area 114 contains graphical and or text data. Clicking on a graphic (e.g. chart or picture) causes an action to occur. Clicking on one of the four column headings shown in FIG. 7 causes the redisplay of the content area sorted by the contents of that column. Clicking on a data element, such as data element 116, causes an action such as trading or the further display of additional information.

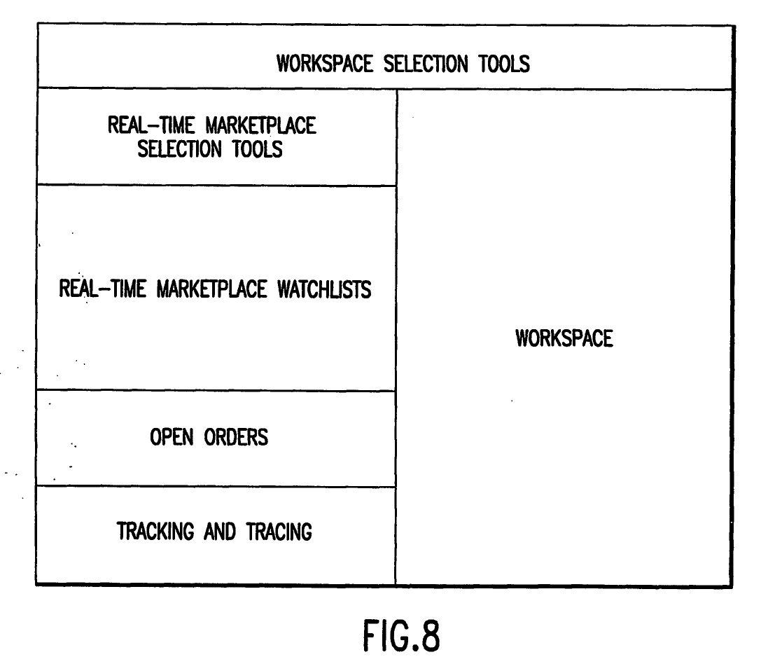

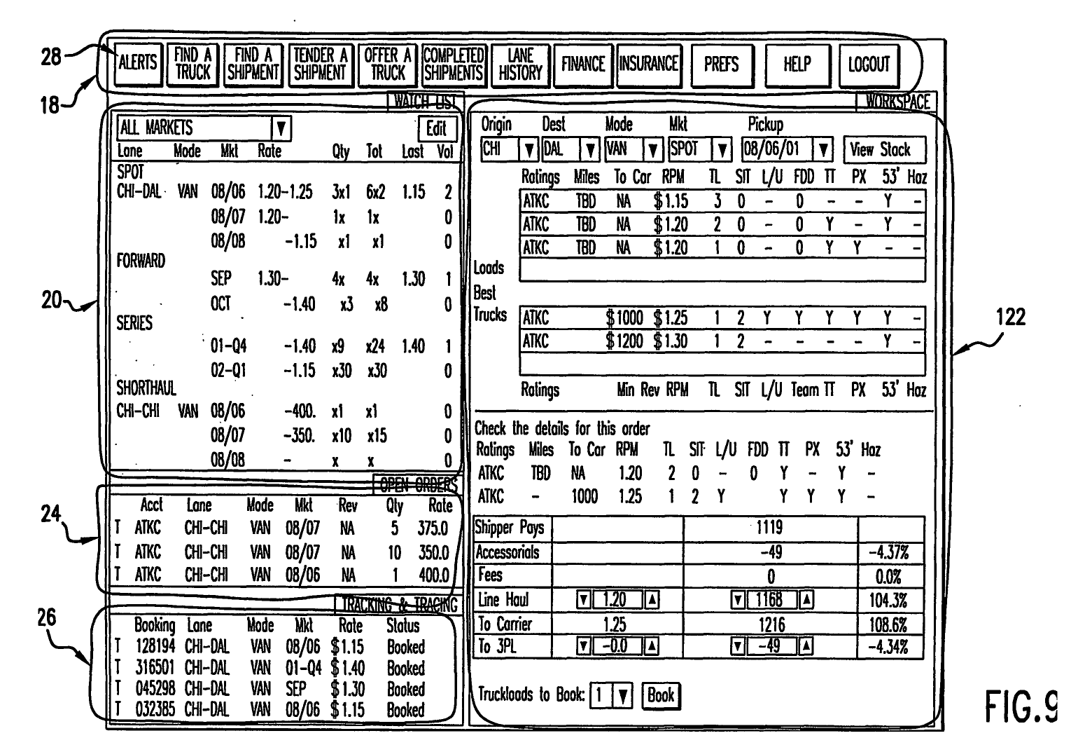

FIG. 8 illustrates an exemplary TrantisLink graphical navigation bar containing six links, defined as follows.

1. Workspace Selection Tools

A set of software tools to select which transportation data entry tool or applet to load in the workspace.

2. Real-time Market Watchlist Selection Tools

A set of software tools to select which set of transportation instruments to display as a real-time marketplace watchlist.

3. Real-time Marketplace Watchlist

A display of the basic market parameters of a number of transportation instruments. Selecting a transportation instrument in a watchlist causes the display of additional information in the Workspace link regarding the underlying details of the marketplace for that transportation instrument to facilitate the trading of that instrument. Unlike other websites, TrantisLink does not display shipments or capacity that are not currently available or cannot be acted upon.

4. Open Orders

A display of a summary of the last few open orders (shipments or capacity whether or not in the currently displayed real-time market). When the user places an order it is displayed at the top of this link to give the user visual confirmation that the system has placed the open order into the marketplace. When the order is booked or cancelled it is removed from this link to give the user visual confirmation that the system has fulfilled the request and removed it from the marketplace. Selecting an open order displays additional information on open orders in the Workspace link.

5. Tracking and Tracing

A display of a summary of the last few orders that have been booked indicating their current status and additional information that may be used in managing the shipment. When the user books a shipment or truck it is displayed at the top of this link to give the user visual confirmation that the system has booked the order and removed it from the marketplace. When the order is completed it is removed from this link to give the user visual confirmation that the system has fulfilled the request. Selecting a shipment in the tracking and tracing link causes the display of additional information on the tracking and tracing of shipments and trucks in the Workspace link.

6. Workspace

A data entry or applet link facilitates the display and entry of basic market parameters for a transportation instrument. Typical functionality includes but is not limited to Find a Truck, Find a Shipment, Offer a Truck, Tender a Shipment, Lane History, Preferences, etc.

Additionally, the TrantisLink system uses Prioritized Scheduled Push (PSP) to maintain the real-time nature of information displayed within the client browser. When the client submits a request to a network server, the server responds by updating the contents of one or more links. The server stores information and periodically, perhaps once every few seconds, updates the contents of all links on the client without any request from the client. The server is able to prioritize the order in which links are updated and match its signaling to the bandwidth of the communication channel.

### Ancillary Services and Products of TrantisLink

This section presents a brief summary of ancillary services and products provided by TrantisLink.

TrantisLink software is also used to perform industry standard validation of insurance coverage. In many cases this includes an interface to the underwriting insurance company. Also, using TrantisLink, insurance agents provide information on insurance to shippers and/or carriers.

TrantisLink software is also used to sell transportation cargo and liability insurance.

TrantisLink software is also used to facilitate and track payments. This includes an interface to one or more factor receivable banks.

TrantisLink software is also used to facilitate and trade insurance claims. In many cases this includes an interface to the underwriting insurance company. Managing 3PLs and 3PLs provide services to their shippers and carriers including but not limited to cash advances, fuel purchase information, etc. Furthermore, banks use TrantisLink to provide the factoring of payment receivables.

Spot and historical prices, shipping demand, and transportation capacity data are available as optional data products. TrantisLink supports the use of both EDI message structures and XML aggregation and syndication (note: aggregation is the process of collecting data from disparate sources; syndication is the process of distributing data to disparate channels) to support data interchange within the transportation community. It should be noted that the present invention could implement any current technology that provides the latest and most effective distribution and promotion of data and user interactivity. Specifically, the TrantisLink system supports order entry and monitoring by importing and exporting .CSV files (comma separated variable, e.g. MS Excel Spreadsheets) in a pre-defined format. Exported files are used by a legacy system or any other type of known database to generate standard reports.

Subjective evaluation of the performance of carriers developed by survey of shippers and background information on carriers will be made available through a websites such as www.CarrierRankings.com. The TrantisLink system may be linked into major Enterprise Resource Planning (“ERP”) and major Customer Relationship Management .(“CRM”) systems. The TrantisLink user base is initially within the United States, Mexico, and Canada. Any transport must have either an initial pickup location or a final delivery location within the continental United States. TrantisLink will be operational 24 hours a day seven days a week absent any exceptional maintenance.

### Effect of Disconnection

Users may specify preferences for open order processing when they either intentionally logout or are unintentionally disconnected. They may choose different preferences for each. Upon disconnection they may:

1. Remain active in the market

The system keeps the orders in the open state but marks the user connectivity as “none”. While open, an aggressor may act upon the order. A booked shipment will make a status transition from “open” to “booked—not confirmed” since connectivity is “none”. When the user next logs in their connectivity is marked as “connected”, they are notified that their open shipment has been accepted, and the shipment will make a status transition from “booked—not confirmed” to “booked—confirmed”.

2. Be removed from the market and open orders be marked subject

The system makes a status transition from “open” to “subject” and marks the user connectivity as “none”. The order may not be booked. When the user next logs in their connectivity is marked as “connected” and the order that was “open” continues to be indicated as “subject”. The user must resubmit the order to change its state to open

3. Be removed from the market and open orders be marked cancelled

The system makes a status transition from “open” to “deleted” and marks the user connectivity as “none”. The shipment may not be booked. When the user next logs in their connectivity is marked as “connected” and the order, which was “open”, is now unavailable on the system. The user must re-enter all of the parameters of the order and then resubmit the order to change its state to “open”.

### Account Maintenance

The “TrantisLink System Account” is the fixed top-level account. AU other firms are one level down in the hierarchy as sub-accounts of the top-level firm. Any account at this level can add a virtually unlimited number of sub-accounts at one further level down. All of these child sub-accounts are treated as subordinates of the parent firm immediately above them, which is ultimately responsible for all of their TrantisLink-related activity.

All accounts are created only as a result of an application process. The parent firm is solely responsible for creating, suspending, removing and managing the activities of any child sub-account it might want to create.

TrantisLink assigns and manages requirements including insurance and credit limits for all top-level (firm) accounts. A credit limit specifies a maximum dollar value of open shipments that an account and all of their sub-accounts may have within the system. A firm, in turn, is free to assign and manage credit limits to all of its sub-accounts. The TrantisLink system ensures that an order may not be placed with an account (or sub-account) if it violates a credit limit of this account or a total credit limit of a parent account.

### Security Features of the TrantisLink System

TrantisLink encrypts all information transmission. All TrantisLink applications require the user to enter a valid user ID and password set to access the TrantisLink system. TrantisLink maintains the privacy of all account information pursuant to its privacy policy. The system allows each user to have only a single access to the system at a time. If the user enters a valid login and password for an account that is already active from a second GUI he will receive an error message that access is denied because the account is already logged on.

The TrantisLink system software has primary site redundancy for all critical components. It is operated as part of a multi-site duster with fully operational servers located within at least two sites. Complete failure of one site may reduce throughput without taking the system out of service. The TrantisLink system is able to create and manage offsite backups of all processed data in an industry standard format.

### Description of Various TrantisLink Displays

The TrantisLink main screen, shown in FIG. 9, is divided into five logical areas: an action button bar 118; a watchlist 120; a workspace 122; an open orders summary display 124; and a tracking and tracing summary display 126.

1) Action Button Bar 118

Action buttons give users access to various transactional procedures. For example, the leftmost button, “Alerts” 128, allows the user to cause a list of received alerts to be displayed in the workspace 122.

2) Watchlist (Market Summary Display) 120

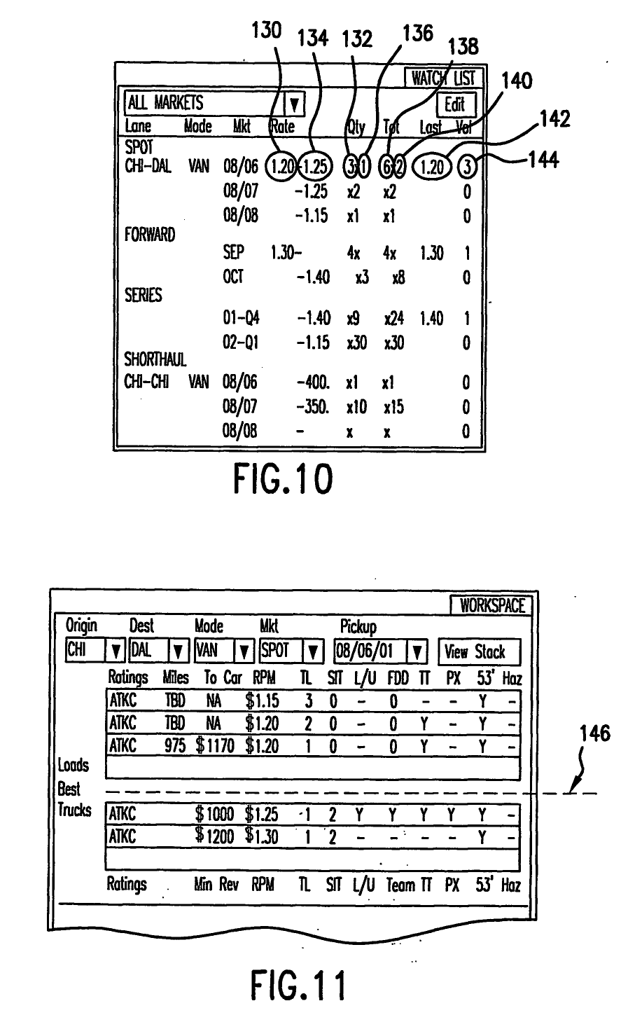

FIG. 10 is an isolation of the watchlist of FIG. 9.

Spot Instruments:

The spot instruments shown in FIG. 10 represent the aggregation of all dry van TrantisLink shipments and capacity from the “Chicago” zone to the “Dallas” zone that are currently available on August 6^{th}, 7^{th} and 8^{th}. The highest shipper bid price on August 6^{th} 130 is $1.20 a mile and three shipments 132 are ready to go at that rate. The lowest carrier offer price 134 is $1.25 a mile and one truck 136 is ready to go at that rate. There are a total of six shipper bids 138; i.e. there are three other shipper bids at less than the best price in the stack of bids. There are a total of two carrier offers 140; i.e. there is one other carrier offer at higher than the best price in the stack of offers. The last booking 142 was at $1.20 a mile and there were 3 bookings since the market opened 144.

Forward Instruments:

The forward instruments also shown in FIG. 10 represent the same aggregation of all dry van TrantisLink shipments and capacity from the “Chicago” zone to “Dallas” zone currently available for a pickup during September or October. The bid price for September is $1.30 and there are 4 shipments available at that price and in total. There are no current offers of capacity. The last forward booking was at $1.30 a mile and one booking was made since the market opened.

Series Instruments:

The series instruments shown in FIG. 10 represent the same aggregation for the same lane available for periodic pickups during the 4^{th} quarter of 2001 and the 1^{st} quarter of 2002. It is assumed that the quantities are daily shipments and trucks since no “modifiers” are given in the instrument name. TrantisLink uses the prefix “W” to change to weekly quantities, and the prefix “M” to change to monthly quantities. The parameter values have the same interpretation as spot and forward instruments.

Shorthaul Instruments:

The shorthaul instruments shown in FIG. 10 represent the aggregation of all dry van TrantisLink shipments and capacity within the “Chicago” zone on August 6^{th}, 7^{th} and 8^{th}. The booking consists of any reasonable number of pickups and deliveries on the same day as long as the driven returns to the terminal on the same day. No shipments are bid for any of the days. The lowest carrier offer price for the day is $400 for the single truck available on the sixth. The best price for the day on the seventh is $350 and ten trucks are available at that price. There are five additional trucks offered at poorer prices on the seventh. No shorthaul bookings have occurred since the market opened.

3) Workspace (Market Detail Display) 122

As shown in FIG. 11, clicking on a transportation instrument in the Watchlist causes the following Market Detail Display to be shown and automatically updated in real-time in the workspace 122.

Each workspace row summarizes the details (i.e. the “trees”) of one or more similar (fuzzy) shipments or trucks. The rates and prices are expressed in net amounts available to a carrier; the price is the sum of the line haul charges plus accessorials for services such as extra stops-in-transit, loading and unloading, extra waiting time, etc. All fees are subtracted from the gross fee prior to its display. The information is presented in order of increasing rate per mile from top to bottom. Hence, the first row is the lowest rate that any shipper is willing to pay; and bottom row is the highest rate any carrier is asking.

In FIG. 11, available shipments are shown above the dashed line 146; where each row displays:

| | |
|---|---|
| Ratings | A series of ratings for the shipper or in this case the abbreviated |
| | name of the shipper |
| Miles | Total number of route miles including all stops-in-transit (in |
| | some cases the miles are “To Be Determined” because the |
| | detailed shipping information is not yet available). |
| To Car | Total amount to be paid to the carrier including all accessorials |
| | (in some cases the amount to be paid is “Not Available” because |
| | the detailed shipping information has not yet been entered). |
| RPM | Line haul Rate Per Mile |
| TL | Number of trucks required |
| SIT | Number of stops-in-transit |
| L/U | Loading/Unloading required |
| FDD | Unusual first delivery date |
| TT | Carrier must have TrantisTracker capability |
| PX | Pallet exchange required |
| 53′ | 53 foot dry van required |
| HAZ | Hazardous cargo |

In FIG. 11, available trucks are shown below the dashed line 146; where each row displays:

| | |
|---|---|
| Ratings | A series of ratings for the carrier or in this case the abbreviated |
| | name of the carrier |
| MinRev | Minimum total revenue that the carrier wants for the trip |
| RPM | Line haul Rate Per Mile |
| TL | Number of trucks required |
| SIT | Maximum allowable number of stops-in-transit |
| L/U | Loading/Unloading will be provide |
| TEAM | Carrier has “team” drivers to support expedited delivery |
| TT | Carrier supports TrantisTracker capability |
| PX | Carrier will provide pallet exchange |
| 53′ | 53 foot dry van available |
| HAZ | Hazardous cargo |

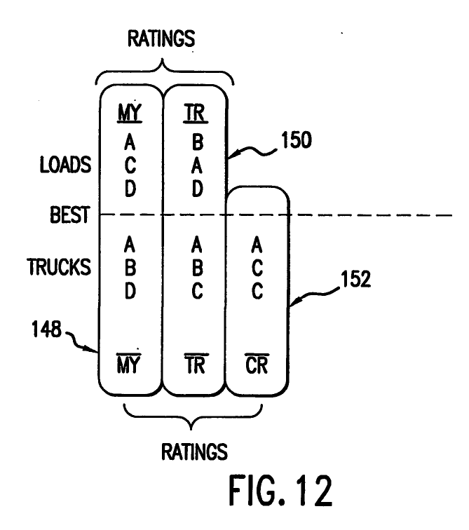

FIG. 12 illustrates how marketplace anonymity is maintained by replacing the names of shippers and carriers by “ratings”. The column previous used to display the name are replaced by up to three different types of ratings. The first column 148 with heading MY represents the user's subjective opinion of the shipper or carrier. The second column 150 with heading TR represents an objective TrantisLink rating based on the accumulated experience of all users on the system with a particular shipper or carrier. The third column 152 with heading CR represents the subjective opinion of all shippers as surveyed in www.carrierrankings.com

4) Open Orders Summary Display 124

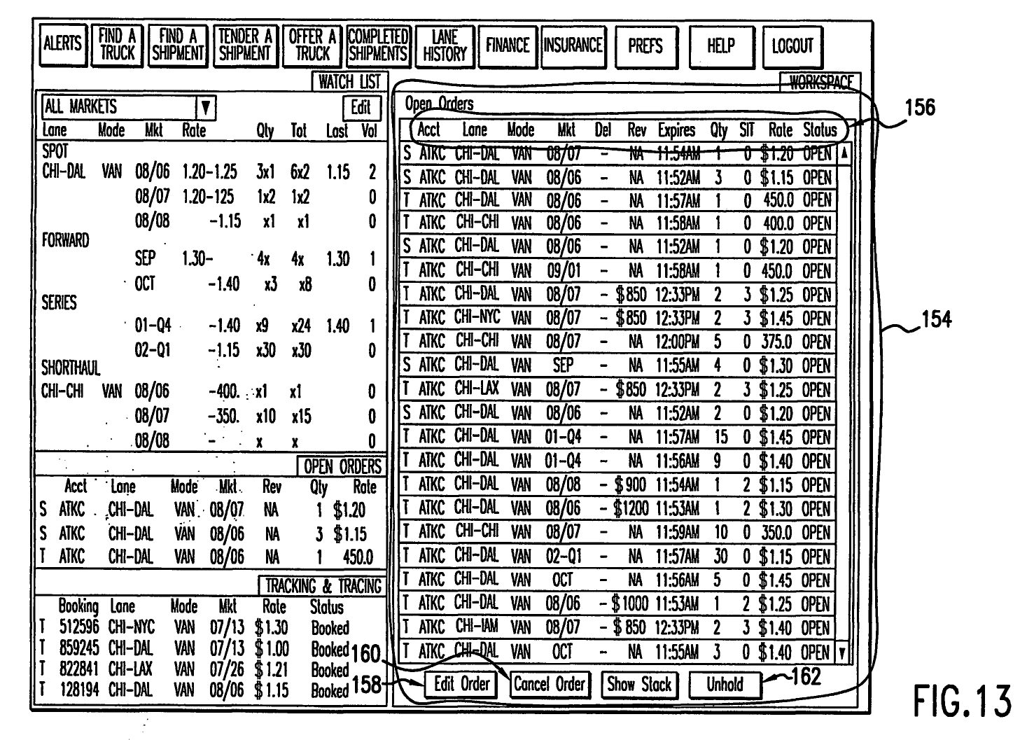

Current unfilled market orders tendering shipments and offering trucks are presented. The user clicks on the heading or a specific order to display a complete summary list of open orders 154 in the Workspace as shown in FIG. 13. Users click on one or more column headings 156 to sort the list by that column.

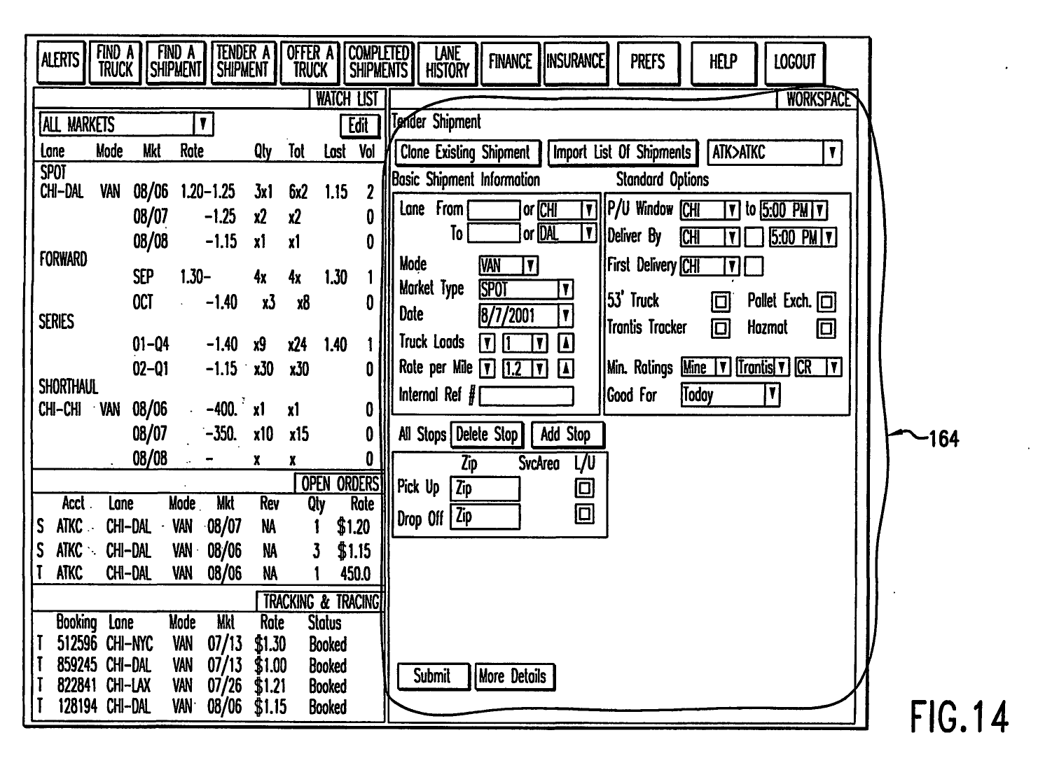

Users may then modify 158, cancel 160 or “unhold” 162 the open order. Editing the order causes the Workspace display 122 to be replaced with a Tender Shipment display 164 as shown in FIG. 14 with all original unmodified shipment parameters automatically preloaded.

5) Tracking and Tracing Summary display 126

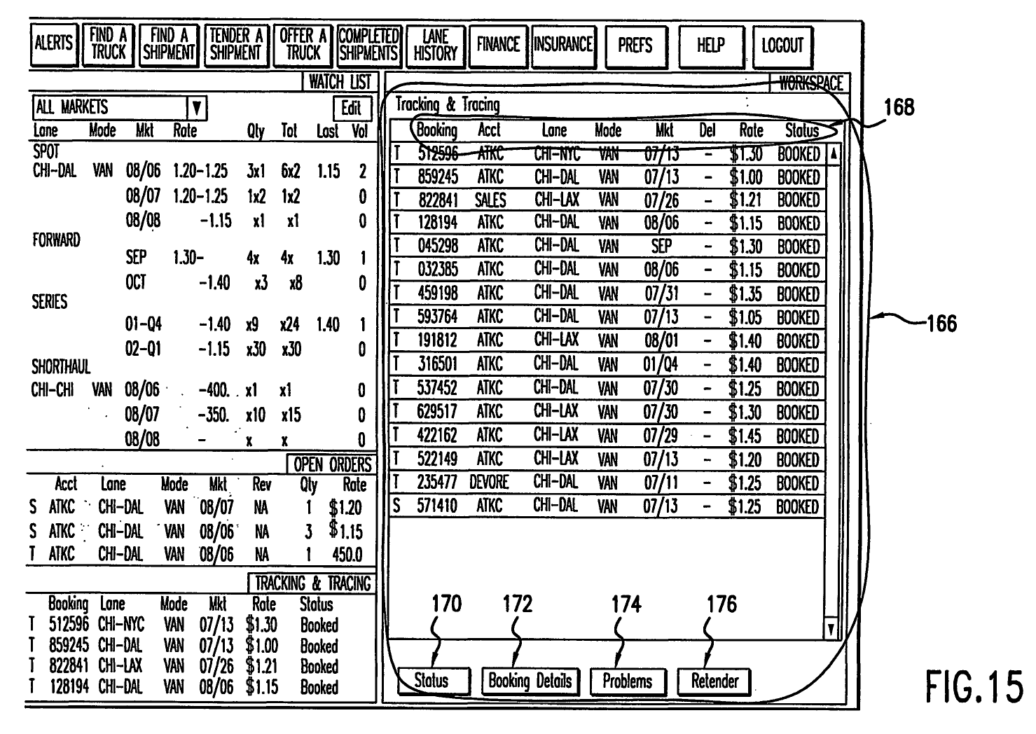

A brief summary of currently active or incomplete bookings is presented. The user click on the heading or a specific booking to display a complete list of incomplete bookings 166 as shown in FIG. 15. Users click on one or more column headings 168 to sort the list by that column.

Users then check the status of a booking by clicking the Status button 170, or display details of a booking by clicking the Booking Details button 172, or report events and/or problems by clicking the Problems button 174, or re-tender a shipment by clicking the Re-tender button 176.

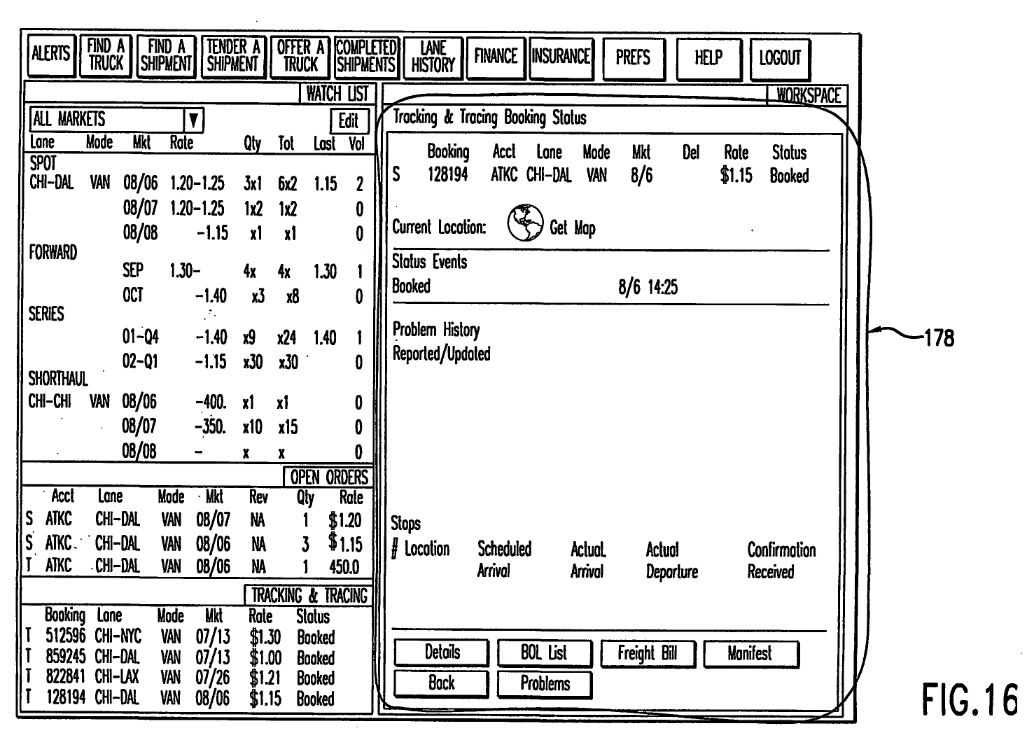

FIG. 16 shows the Tracking and Tracing Booking Status display 178.

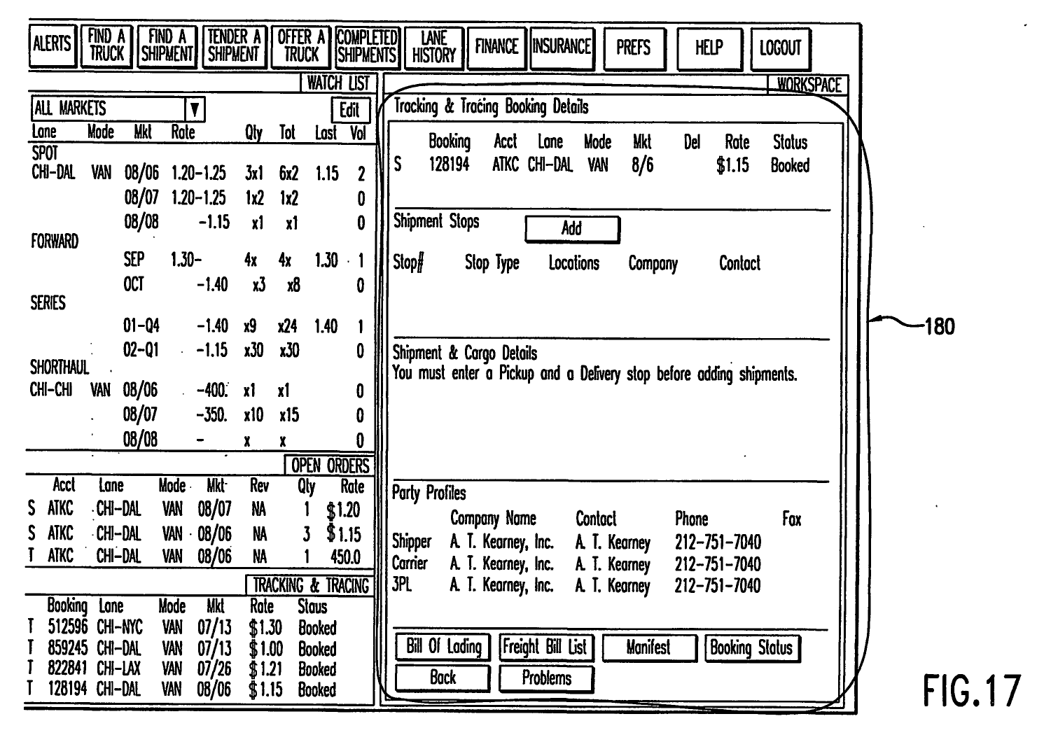

FIG. 17 shows the Tracking and Tracing Booking Details display 180.

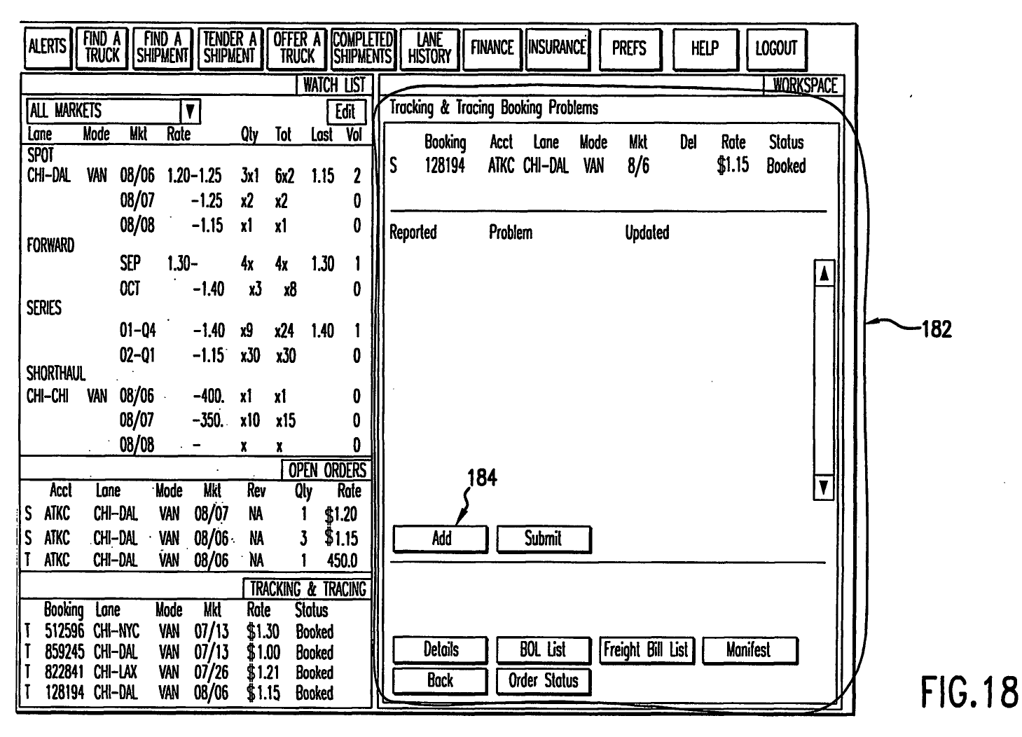

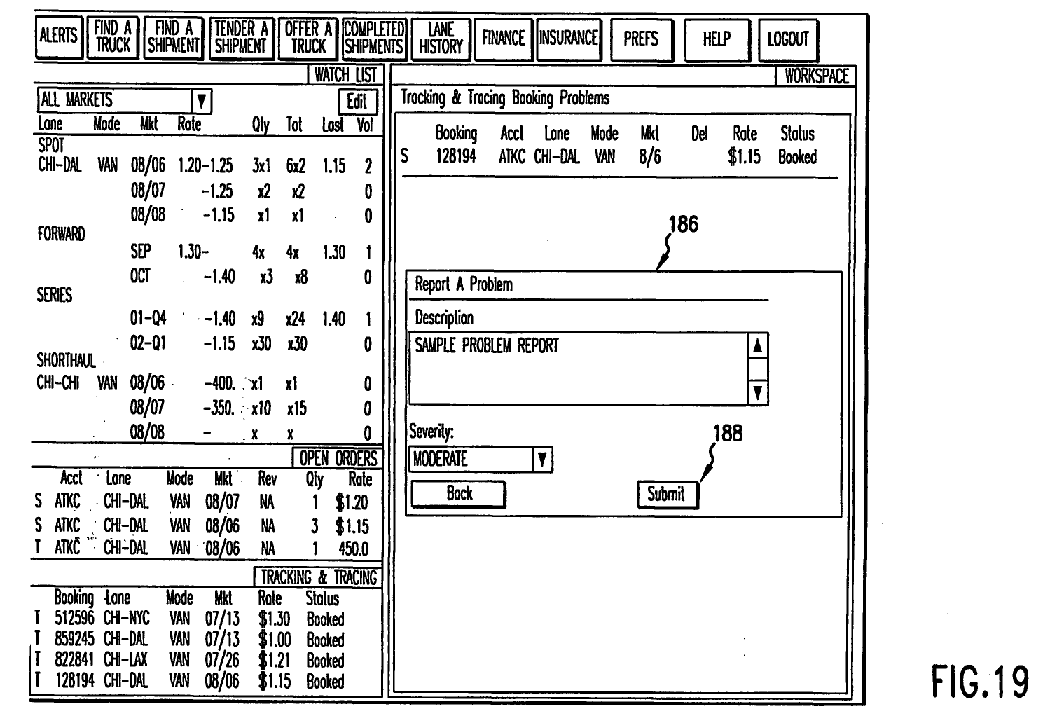

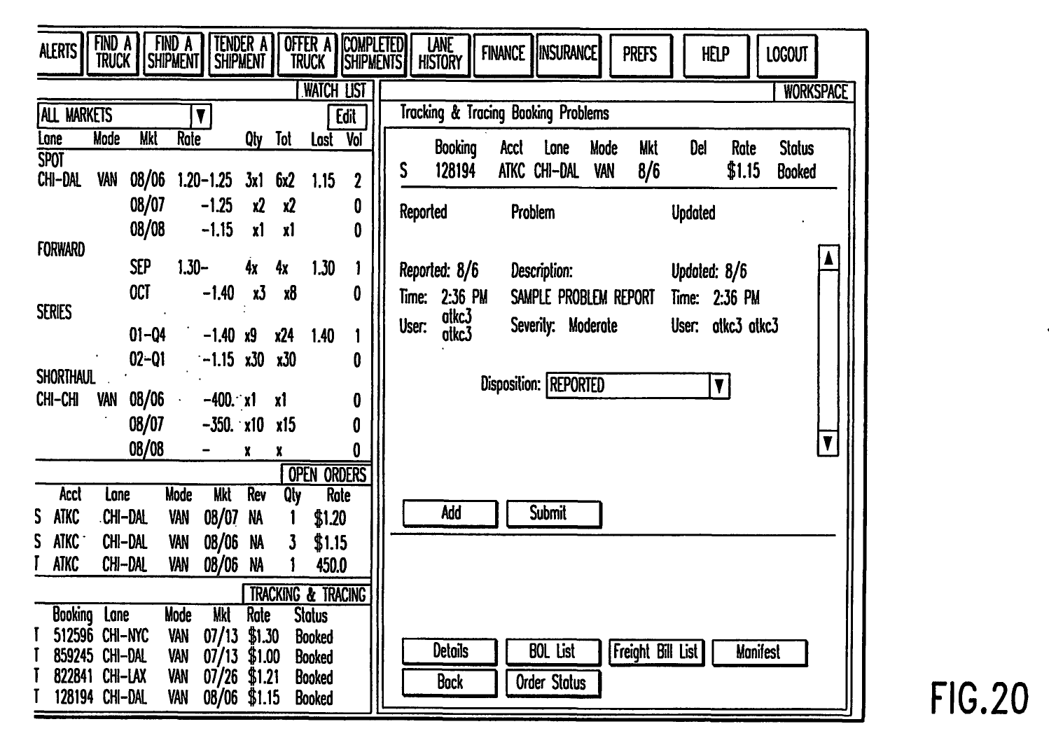

FIG. 18 shows the Tracking and Tracing Booking Problems display 182 which are used to report and update problems and status. Clicking the Add button 184 causes the display of the Report a Problem data entry window 186 as shown in FIG. 19. The problem is submitted by clicking the Submit button 188 after entering the text describing the problem and characterizing its severity causing the display shown in FIG. 20.

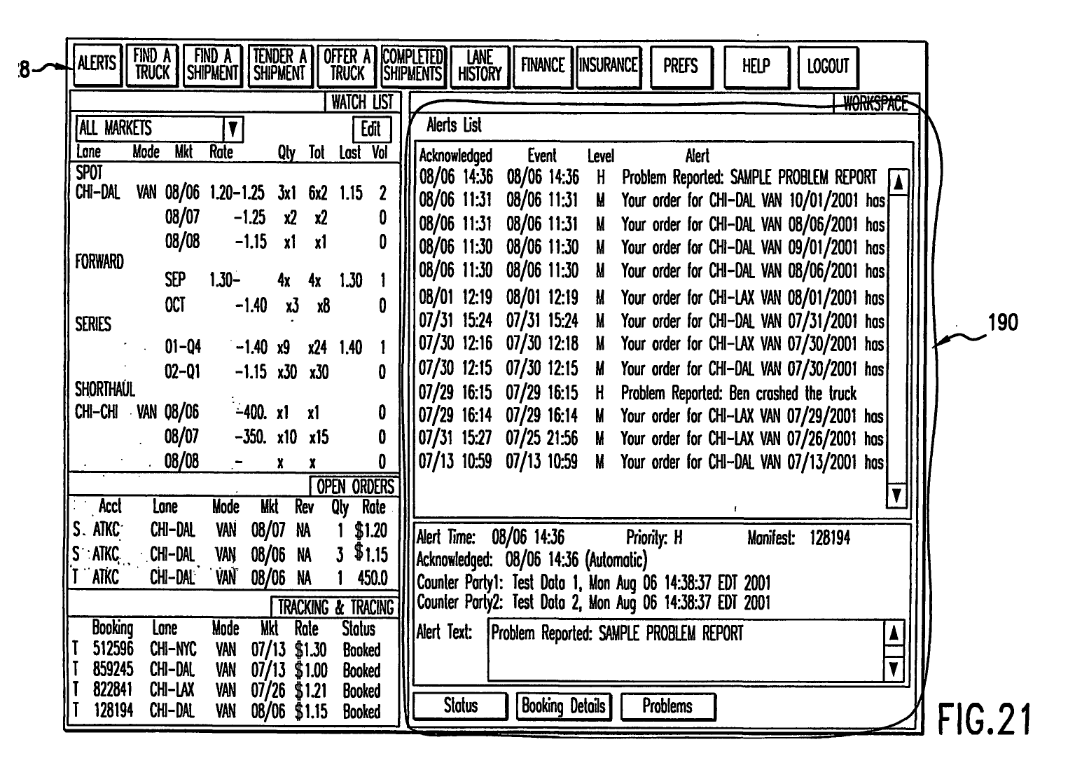

All counterparties to the booking receive automatic alerts 190 as shown in FIG. 21. This window is displayed by clicking the Alerts button 128.

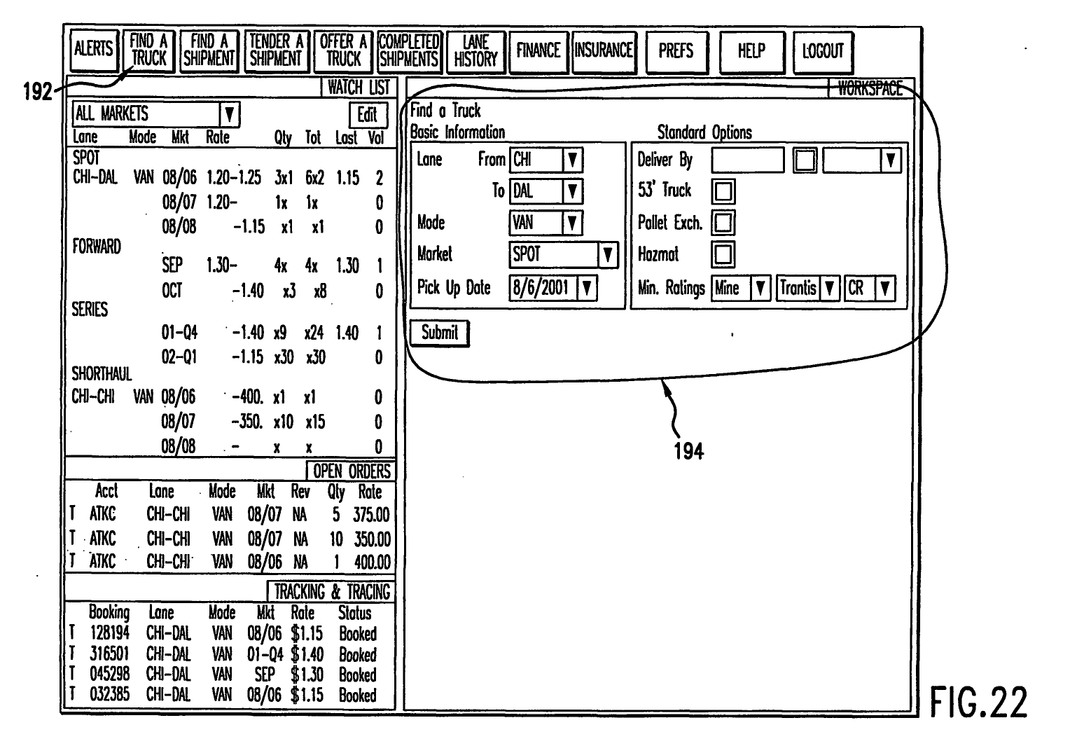

As shown in FIG. 22, clicking the Find-A-Truck button 192 displays the Find A Truck data entry window 194 which may be automatically preloaded with previously used parameters.

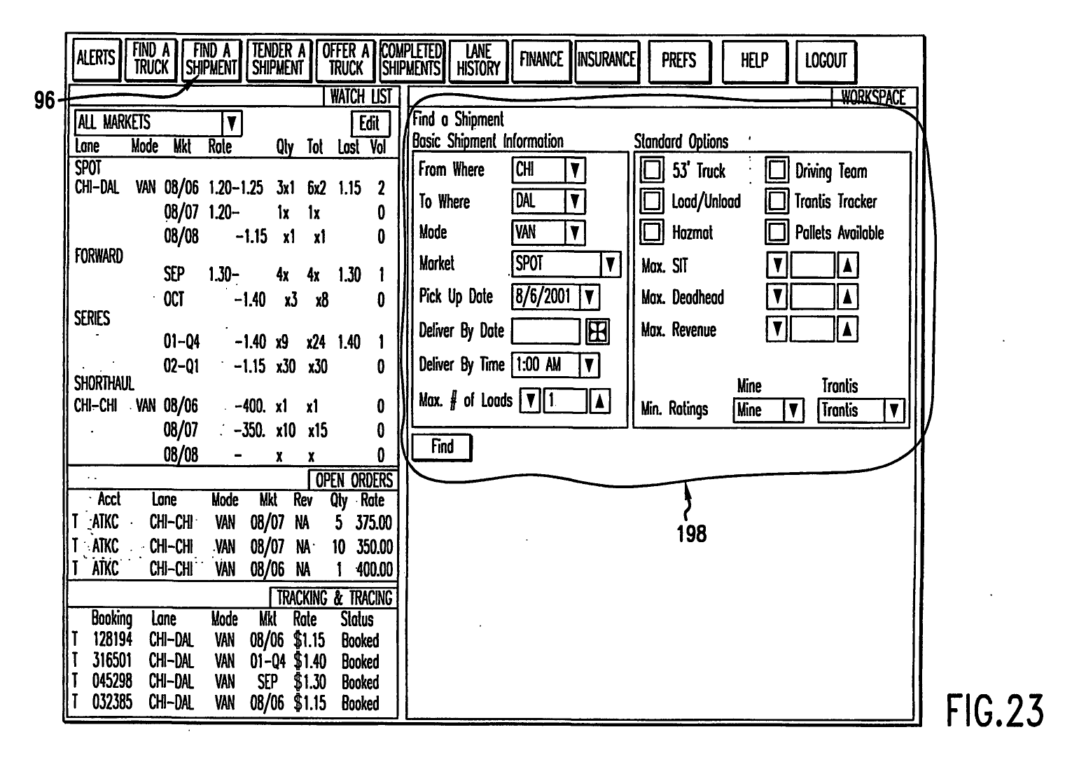

As shown in FIG. 23, clicking the Find A Shipment button 196 displays the Find A Shipment data entry window 198 which may be automatically preloaded with previously used parameters.

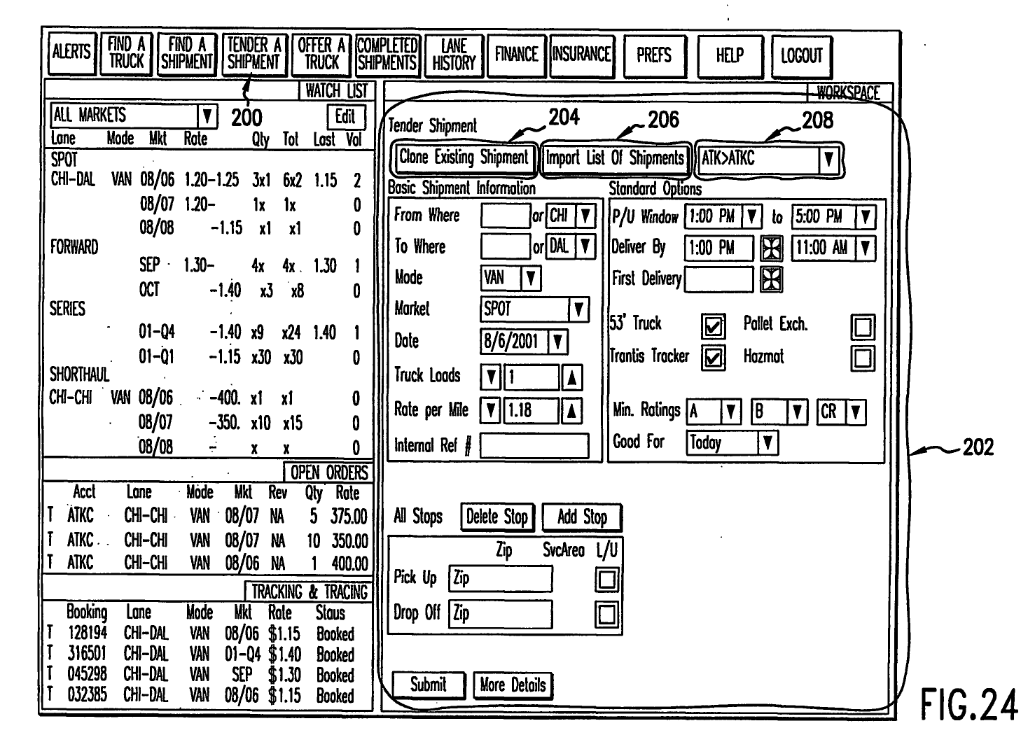

As shown in FIG. 24, clicking the Tender A Shipment button 200 displays the Tender A Shipment data entry window 202 which may be automatically preloaded with previously used parameters. Users may use the Clone Existing Shipment button 204, Import List of Shipments button 206, or change customer button 208. Shipments may be “basically” or “completely” tendered. Basically tendered shipments do not contain all of the shipment parameters that would be necessary for transporting the cargo. For example, a basically tendered shipment may not contain the specific origin and destination addresses. A completely tendered shipment contains all the details necessary to transport the cargo.

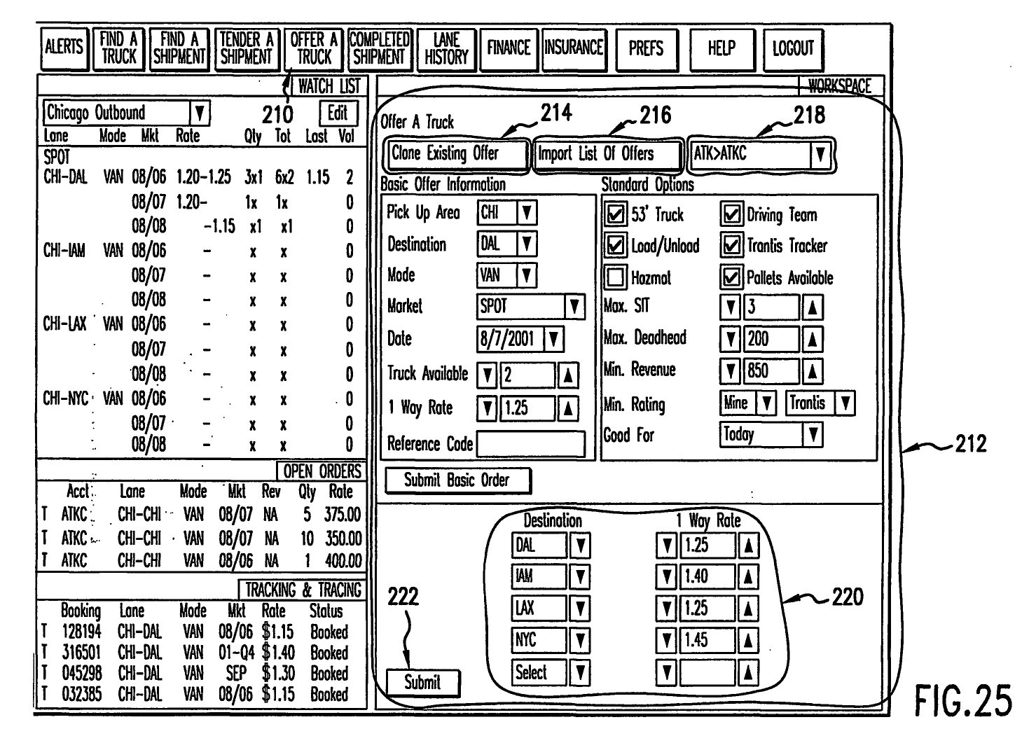

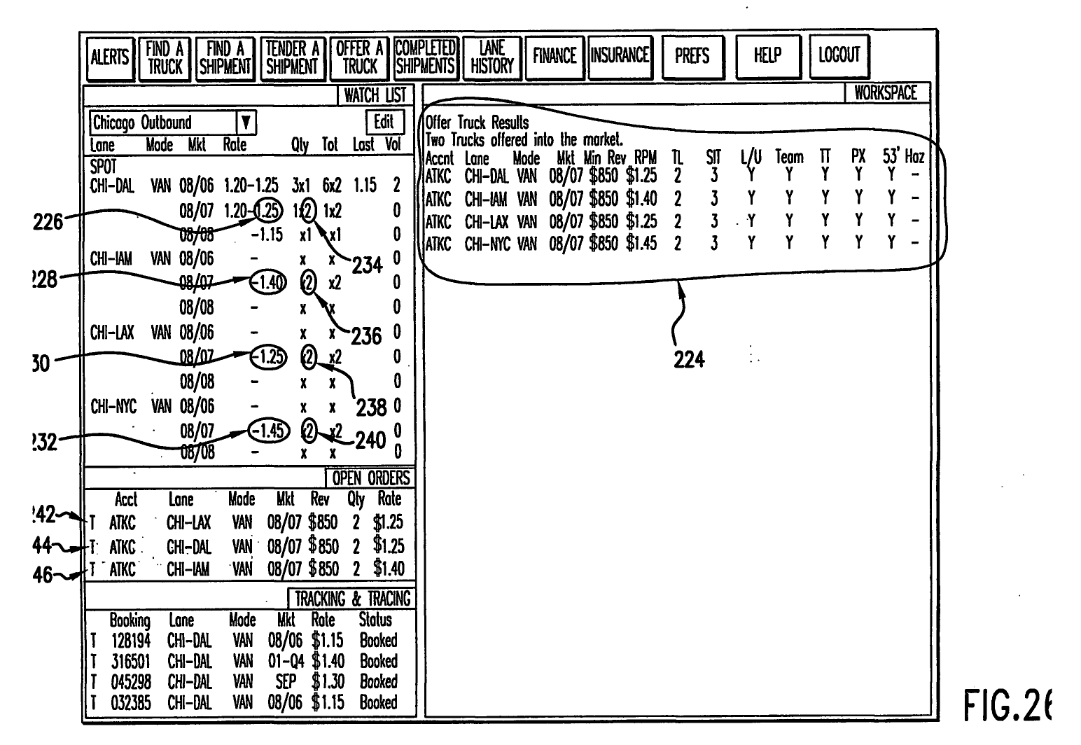

As shown in FIG. 25, clicking the Offer A Truck button 210 displays the Offer A Truck data entry window 212 which may be automatically preloaded with previously used parameters. Users may use the Clone Existing Offer button 214, Import List of Offers button 216, or change customer button 218. Trucks may be “singly” or “multi” offered. Basically offered trucks have a single destination zone. A multi-offered truck has more than one possible destination and rate per mile. These destinations and rates are entered in area 220 and submitted by clicking the Submit button 222. The TrantisLink system responds as shown in FIG. 26 by displaying the Offer Truck Results window 224, modifying the Watchlist 120 to reflect the four contingent offer prices 226, 228,230 and 232 and quantities 234, 236, 238 and 240, and modifying the Open Orders Summary Display 124 to reflect the contingent truck offers 242, 244, 246 and 248 (off screen).

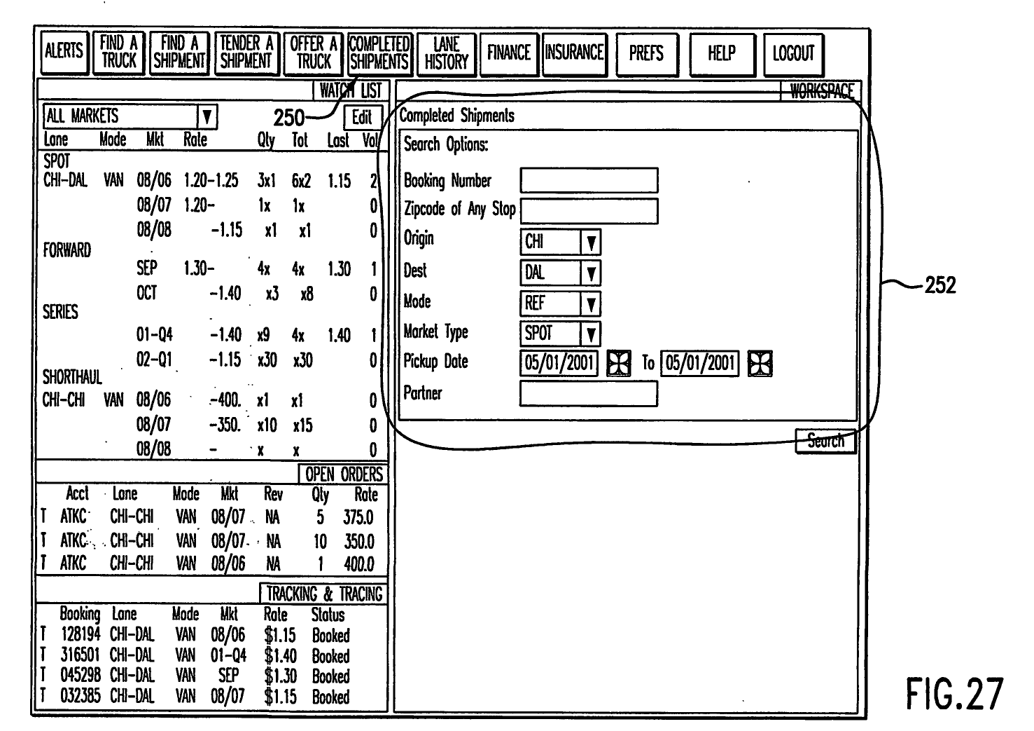

As shown in FIG. 27, clicking the Completed Shipments button 250 displays the Completed Shipments data entry window 252 which may be automatically preloaded with previously used parameters.

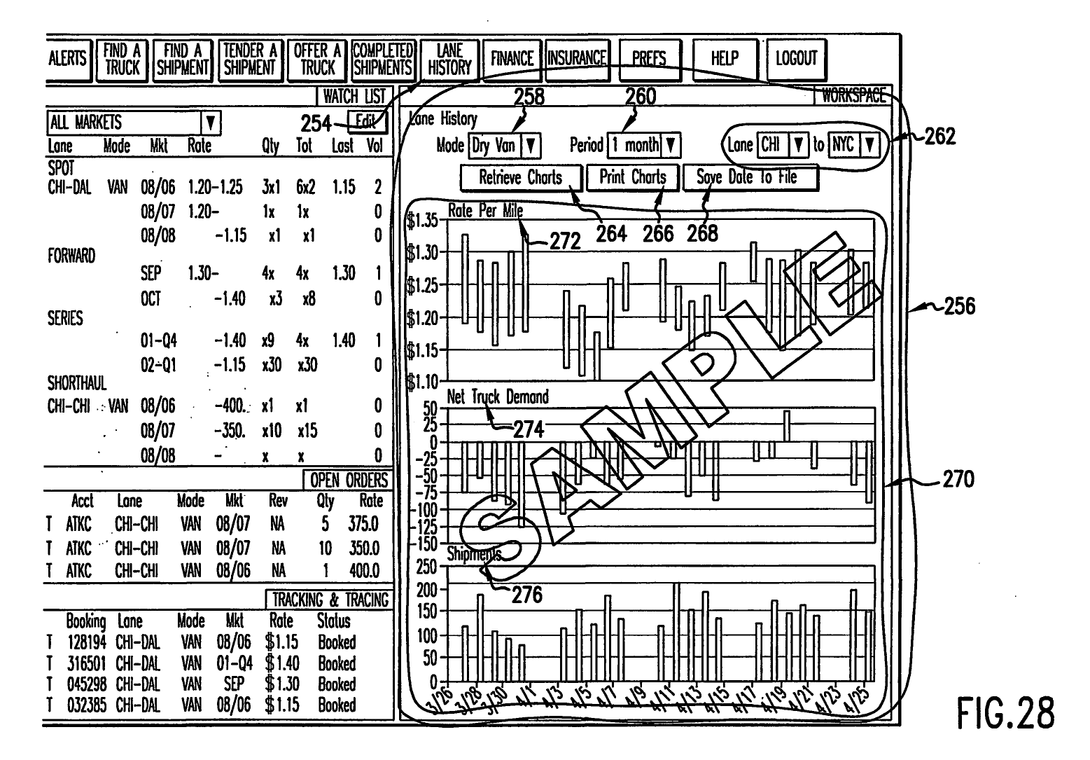

As shown in FIG. 28, clicking the Lane History button 254 displays the Lane History Selection and Display window 256. Users select the mode 258, time period 260 and lane 262. Clicking Retrieve Charts 264, Print Charts 266 or Save Data to File 268 retrieves the corresponding lane history data 270. Shown are the daily range for rate per mile 272, net truck demand 274 and number of shipments 276.

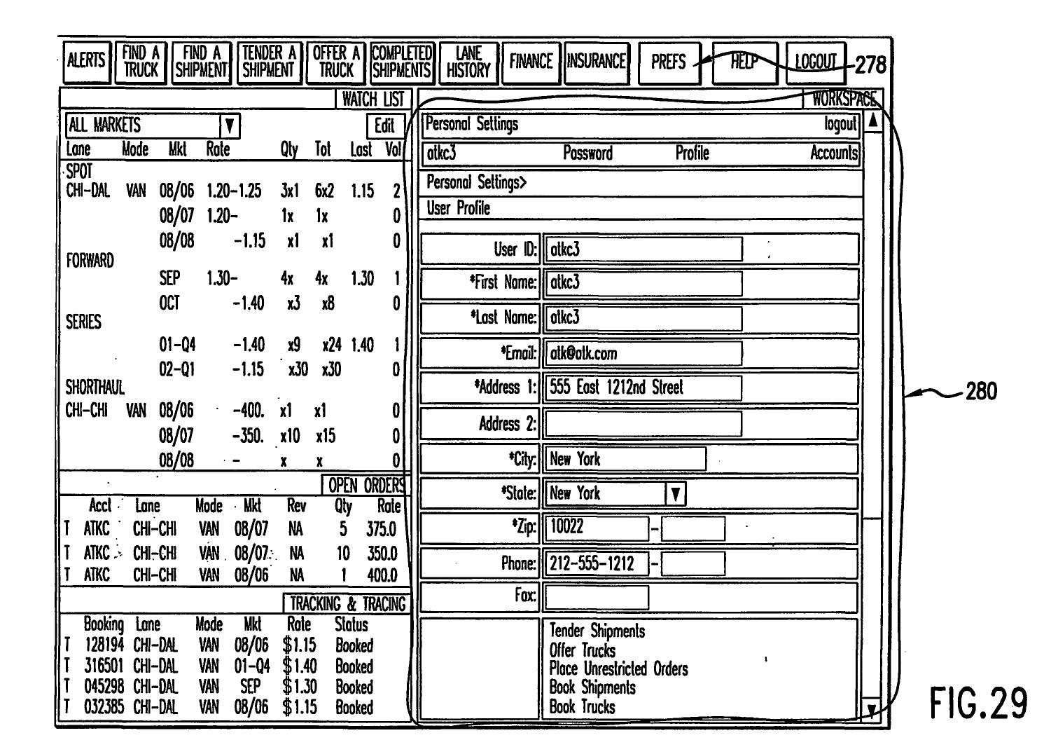

As shown in FIG. 29, clicking the Prefs button 278 displays the Personal Settings data entry window 280.

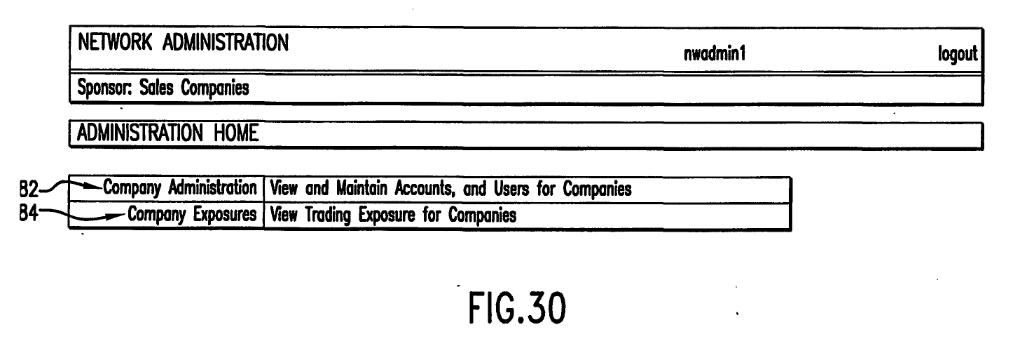

Logging into the Network Administration Site results in the display shown in FIG. 30. The user may click Company Administration 282 or Company Exposures 284 buttons.

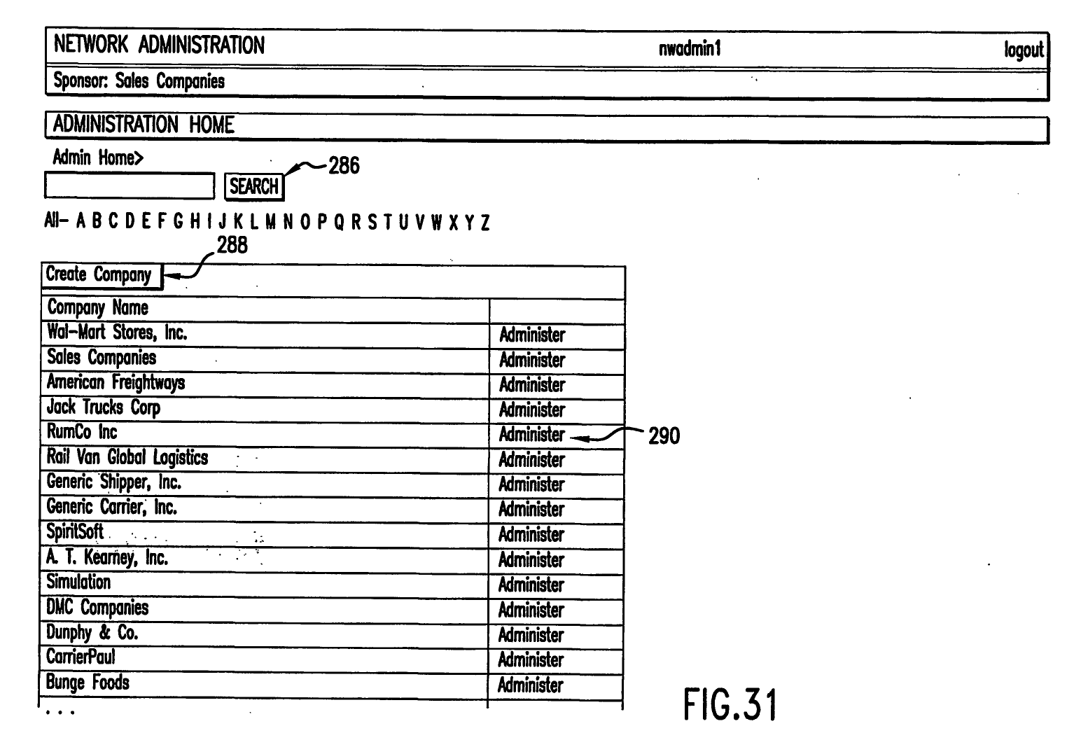

As shown in FIG. 31 the user may view and maintain accounts and users for companies. The user may search for 286, create 288, or select and administer a company 290 (for example Jack Trucks).

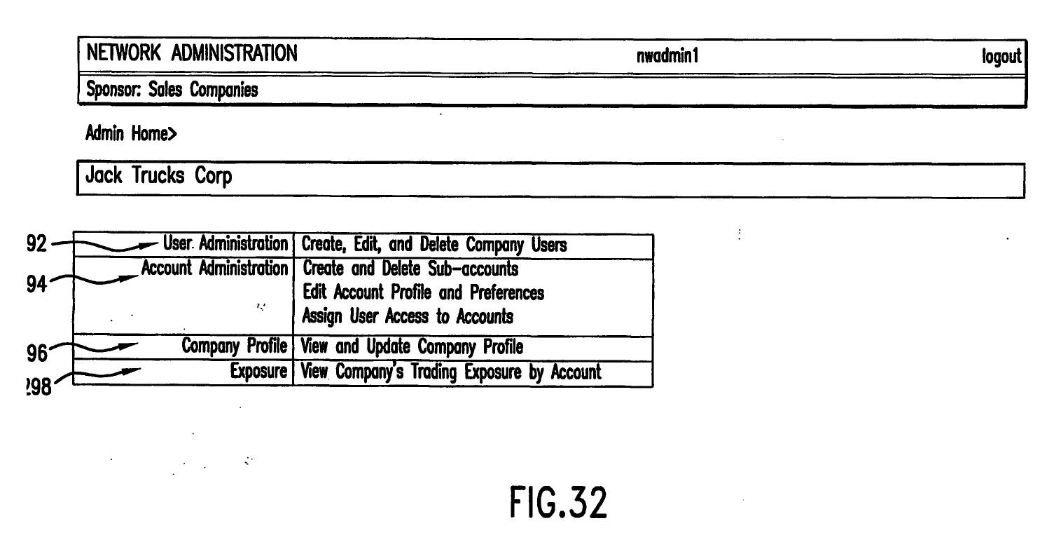

As shown in FIG. 32, the user may administer users 292, administer accounts 294, view and update the company profile 296 or set or view the company's trading exposure 298.

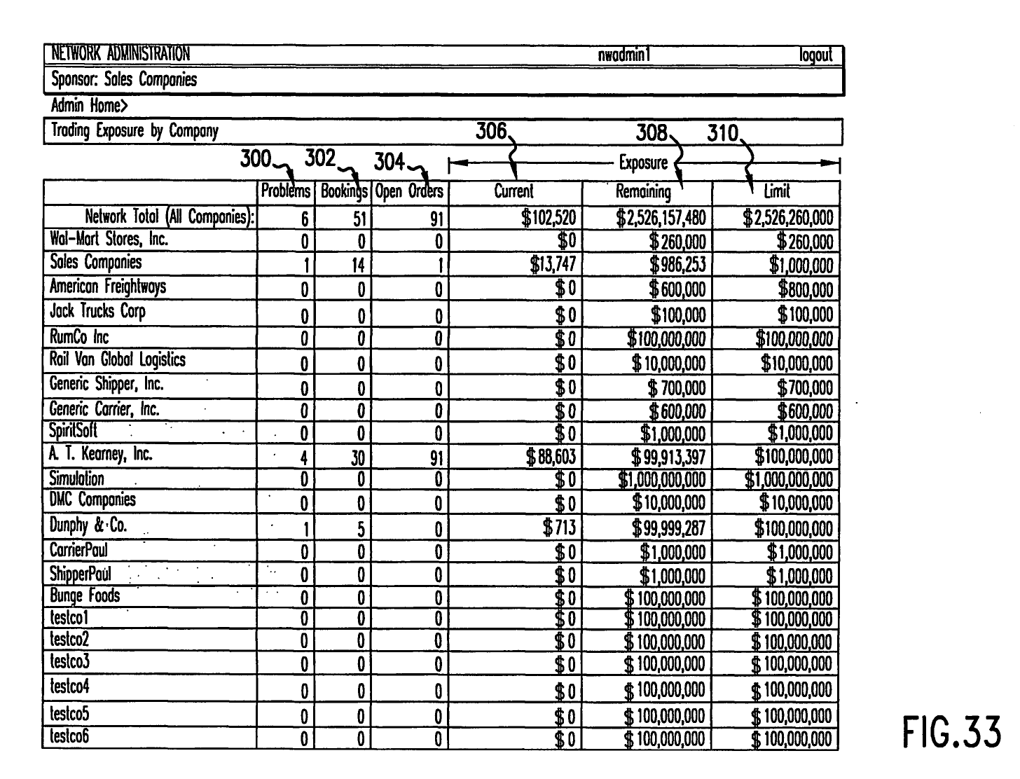

As shown in FIG. 33, the user may view the number of problems 300, bookings 302, open orders 304, current exposure 306, remaining exposure 308, and exposure limits 310 for each company or the entire network.

Thus, TrantisLink enables customers to plan with a far greater degree of confidence than before because TrantisLink provides Best Available rates (shipper bids and carrier offers), total number of currently available shipments and trucks, last trade and daily trade volume, depth of the market including shipment details such as accessorials and special shipment requirements, alerts to transportation problems, tracking and tracing of your loads in transit, completed shipment reports, and even historical rates with supply and demand data.

### Using Series and Forward Contracts to Hedge Price and Availability Risk

The current practice within the transportation industry is for large shippers to select “core carriers” usually on an annual basis by sending candidate carriers a copy of last year's annual freight bills and asking them to provide a single annual rate per mile for each type of shipment in a given lane. The carriers process the annual freight bills to determine the anticipated usage on a monthly basis and then calculate an average rate for the year.

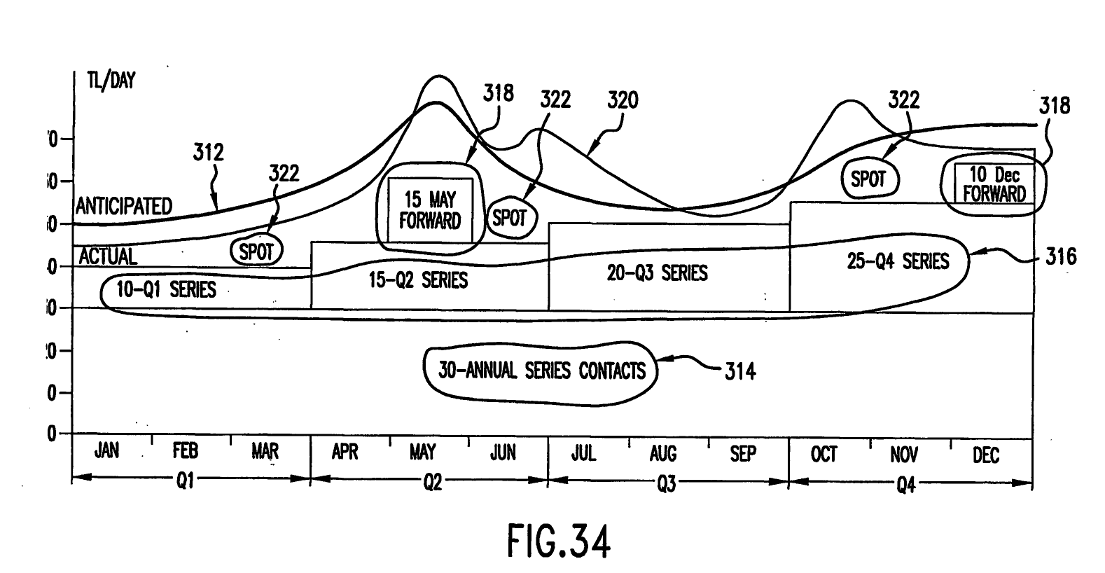

A simpler and more effective methodology of selecting “core carriers” is illustrated in FIG. 34. This process does not require candidate carriers to analyze previous year freight bills to predict monthly usage. Rather, the shipper determines their anticipated usage and bids-out a given number of annual series contracts 314, quarterly series contracts 316 and monthly forward contracts 318 Candidate carriers either accept the bid or respond by offering capacity in each of the instruments. Either the shipper or carrier finally book a contract and make a firm commitment to transport goods with their newly selected “core carrier”. It is possible to book more than one “core carrier” for a partial amount of each contract.

Actual usage 320 usually closely approximates anticipated usage 312. Buying in the spot market 322 fills any shortfall differences. Should actual usage fall below the number of contracts in effect at a given time the shipper sells in the spot market 322.

### Processing External Market Data to Obtain Clean Lane History Rate Per Mile Prices

It is necessary to use standardized accessorial charges to normalize shipment data received from external trading networks.

Consider for example two offers to perform the same 1,000 mile shipment:

| Carrier | Rate Per Mile | Line Haul | Accessorials | Total Price |
|---|---|---|---|---|
| A | $1.20 | $1,200 | $0 | $1,200 |
| B | $1.00 | $1,000 | $200 | $1,200 |

Carrier A has the policy of not charging for the provided accessorials; carrier B has the policy of charging for the accessorials but giving a lower rate per mile.

Using the total price and applying a standard price for the provided accessorials results in dean lane history rate per mile price data. In this example the standard price for the provided accessorials is $100 resulting in a dean rate per mile of ($1,200-$100)/1,000 miles equals $1.10/mile.

### Private Networks and Collaborative Logistics

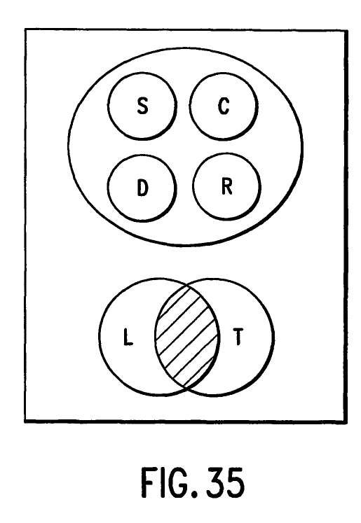

FIG. 35 illustrates a private network run by a sponsor (super shipper or 3PL) who has authorized access for their shippers (S), carriers (C), consignees (R—receivers of goods) and dispatchers (D). Authorized shippers and dispatchers tender loads (L) or find a truck. Authorized carriers and dispatchers offer trucks (T) or find a load. Shippers, carriers and receivers may be authorized to have access to more than one private network; dispatchers usually have access to only one private network.

The intersection (i.e. shaded area) of the tendered loads (L) and offered trucks (T) represents those shipments that have been booked on the private network. The un-shaded areas represent distressed loads and trucks. The word distressed is commonly used in the transportation industry to mean unmatched situations and does not convey the more usual English meaning of low quality or undesirable.

To alleviate the above distress, TrantisLink will also support anonymous collaborative logistics. As the number of interconnected private networks increases a point is reached where the multiply connected private networks will become in effect a public marketplace supervised by multiple sponsors or 3PLs. These supervisors provide human intervention to alleviate problems that may occur in the marketplace during the life cycle of a transaction. Collaborative logistics is the ability of multiple participants to share information for mutual benefit. TrantisLink provides anonymous collaborative logistics as explained below.

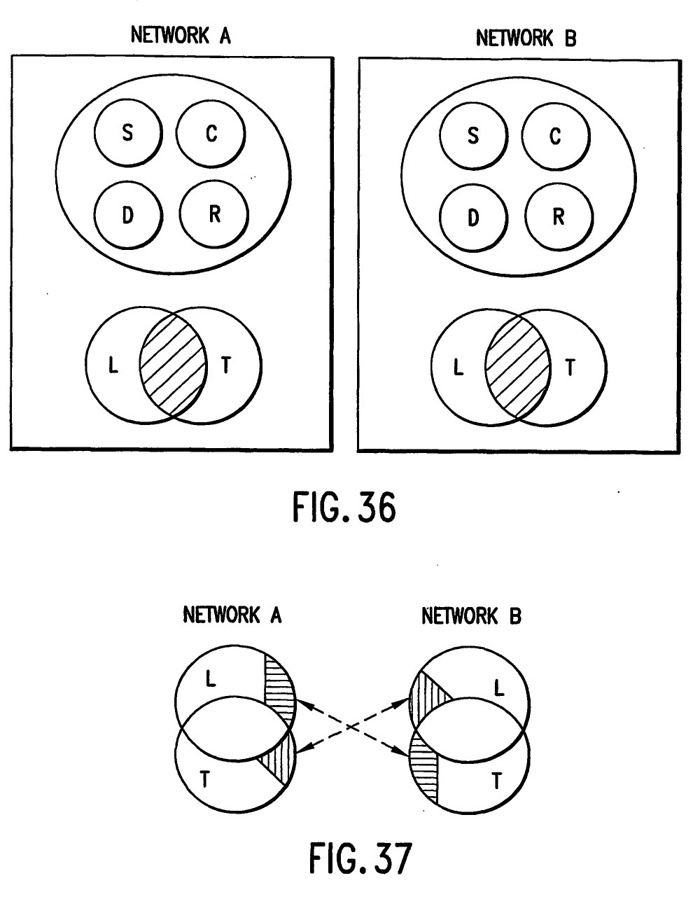

FIG. 36 illustrates two private networks A and B run by two different sponsors, where the two networks are entirely isolated from each other. When private networks are isolated from one another as in FIG. 36, i.e. participants on one network do not have access to information on the other network, so that distressed loads on one network may not be matched to distressed trucks on the other network. Thus, collaboration between the two networks can not be achieved without interconnecting the two networks. However, the advantage of TrantisLink collaborative logistics is that participants do not have to know or enter into agreements with their competitors to gain the benefits of collaboration. Unlike other methodologies, TrantisLink collaborative logistics is truly anonymous.

This is because private networks are but a first step toward public networks. As an Application Service Provider (ASP), TrantisLink provides the unique availability to isolate or interconnect multiple private networks on one physical system. TrantisLink provides collaborative logistics opportunities by interconnecting its private and public networks.

Collaborative logistics, the ability of multiple participants to share information for mutual benefit, occurs when one or more private networks are interconnected such that distressed loads and trucks on one network are matched to distressed loads and trucks on the other network. This is illustrated in FIG. 37, which shows how some of the distressed loads (L) on Network A are matched to some of the distressed trucks (T) on Network B, and vice versa. TrantisLink provides private networks to TrantisLink, sponsors to allow them to offer their existing and new customers (shippers, carriers, and consignees) state-of-the-art easily integrated information-technology at an affordable price.

### TrantisLink Revenue Model

TrantisLink revenue is derived from a combination of transaction fees, license fees for systems and motor carrier market data, and ancillary services. Transaction fees for booking and/or tracking-and-tracing are deducted from shipper payments. This payment methodology is common to the motor carrier transportation industry. Network sponsors pay license fees for private network systems. Subscribers to motor carrier market data pay monthly fees on an annual basis. These are explained in more detail organized by product segment below.

The monthly fee for use of TrantisLink is initially capped. Also, there are no additional fees after a predetermined number of transactions in a month. Cap levels will be increased as product adoption occurs. The minimum monthly fee is the larger of a per user fee or per private network fee. Also, each subscriber can pay a set fee per month on an annual basis for the ability to view (but not download) historical and real-time motor carrier transportation market data. Each subscriber can also pay a set fee per month on an annual basis for the ability to view and/or download historical and real-time motor carrier transportation market data. Subscribers will be prohibited contractually from redistributing the data outside of their own company.

### Advantages of TrantisLink^{SM}

Managing transportation is currently a labor-intensive process. TrantisLink^{SM} enables its users to use contingent order processing to facilitate connecting shippers and carriers. For example, a carrier offers a truck into the marketplace from a single origin but with multiple possible destinations. When one of the offers is accepted all of the other contingent offers are immediately removed.

TrantisLink supports shippers and carriers connected simultaneously to multiple private networks and the public network at one time. This enables them to conduct all of their business with multiple vendors using a single TrantisLink interface, rather than having to use several different types of systems that are not interconnected.

Need: There is an existing marketplace need for customers to receive and respond to shipment exception alerts.

Solution: TrantisLink automatically generates and monitors real-time exception alerts.

Need: 3PLs desire to provide improved services at lower cost.

Solution: The functionality of TrantisLink allows each broker or 3PL to manage five to ten times the number of simultaneous loads than are handled by outdated FAX and telephone technology.

Need: Customers need to improve their order processing efficiency and become more profitable.

Solution: TrantisLink users dick on a market summary line, which will then display the underlying details of loads and available trucks. The relevant parameters for each load and truck are presented in a one-line summary. Users then click on any column heading to sort (rather than scroll through) the list of opportunities and evaluate them. Booking a selected load or truck is as simple as clicking the “book” button. The system then immediately notifies all affected parties.

Need: Easy integration into legacy systems for both shippers and carriers.

Solution: Many users have legacy applications that prepare lists of orders that they want to submit to TrantisLink. Accordingly, TrantisLink system supports order entry and monitoring by importing and exporting CSV files (e.g. MS Excel Spreadsheets) in a pre-defined format. The exported files may be used by the legacy system to generate standard reports. Shippers tender shipments onto TrantisLink and provide one side of the trades on the system. TrantisLink shippers now have an alternative to the annual paper-based carrier “contracting” process. In addition, TrantisLink provides increased supply-chain visibility and the ability to optimize their transportation networks.

Carriers utilize TrantisLink to secure shipments from shippers and better utilize their assets. TrantisLink carriers benefit from the ability to offer trucks, reduced empty miles, and rules that provide stronger contracts than currently available. When the shipment is booked the carrier is immediately notified and both sides have a contractual obligation to perform. The 3PL (either internal or external) receives an alert that the shipment was tendered and relies upon software tools to monitor the normal or exception handling of the order. When exceptions occur the 3PL broker is able to use TrantisLink software to correct the situation. The broker receives notification when insurance is already in place. In most circumstance the broker does not have to use the FAX or telephone. Hence, brokers are able to manage five to ten times the number of loads per day.

Need: Customers need accurate market data prior to making a decision on transportation.

Solution: TrantisLink provides one-line summaries of transportation marketplaces sorted by lane, type of equipment, date, best prices and number of available loads and trucks. Users may also view historical price, demand and daily load data.

Need: Customers want the ability to reduce their uncertainty in the marketplace. Shippers want to lock in capacity for future anticipated needs. Carriers want to predetermine their workload to minimize the cost of asset relocation.

Solution: TrantisLink provides these capabilities by supporting forward and/or series purchases of shipments and trucks.

Need: Shippers want the cost savings associated with collaborating with others without having to identify who they are and then taking on the hassle of negotiating an agreement with every other shipper.

Solution: TrantisLink, automatically identifies collaborative opportunities, checks to ensure that all of each shipper's requirements are satisfied, and then books the transaction without the need to give up any identifying information or any human intervention.

Need: Customers need the ability to lower costs by offering a resource to more than one counterparty at a time; and, when the first counterparty accepts the offer, to have the system automatically remove all of the remaining offers.

Solution: TrantisLink performs this in real time; it is called contingent order processing.

Need: Customers need the ability to increase the probability of finding a backhaul.

Solution: TrantisLink uses contingent order processing to increase the probability of finding a backhaul.

TrantisLink offers “depth of market” displays including one-line summaries of each shipment's details including standard accessorials. TrantisLink possesses automated search functions to “find a truck” or “find a shipment”. TrantisLink also possesses the ability to buy and sell transportation over a period of time in the future to hedge price and availability risk. TrantisLink improves on the current industry practice of annual rate-only agreements without any minimum volume commitments by creating transportation instruments that are backed by enforceable contracts.

Furthermore, TrantisLink offers tracking-and-tracing of all shipments regardless of whether they were booked on a TrantisLink network. This enables shippers and receivers of goods to manage their terminals efficiently even when using more than one carrier. In addition to spot transactions, TrantisLink provides forward and series contracts, a very significant advance over the current standard practice of incomplete annual pricing agreements that do not obligate the parties to minimum volume commitments.

Finally, TrantisLink's market visibility, immediate transaction execution and fulfillment alerts allow each dispatcher to process more shipments. TrantisLink provides real-time and historical information on pricing, availability and fulfillment problems. The transportation instruments created with TrantisLink are backed by enforceable contracts specifying price, pick-up and delivery. TrantisLink offers experienced transportation experts service real-time fulfillment alerts using advanced software tools. TrantisLink also enables shippers and carriers to hedge risk by committing to future obligations. TrantisLink participants may trade-out of their obligations whenever their anticipated needs are not realized.

While the invention has been described and illustrated with reference to specific exemplary embodiments, it should be understood that many modifications and substitutions could be made without departing from the spirit and scope of the invention. Accordingly, the invention is not to be considered as limited by the foregoing description but is only limited by the scope of the appended claims. What is claimed is:

1. A method of brokering transportation transactions, comprising:
receiving into a staging area a plurality of dissimilar bids for shipping goods;
receiving into said staging area a plurality of dissimilar offers for transporting goods;
sorting and aggregating said shipping bids into a set of first fuzzy commodities;
sorting and aggregating said carrier offers into a set of second fuzzy commodities;
selecting matching sets of said first and second fuzzy commodities in said staging area to create transportation instruments; and
creating underlying contracts to support the trading of said transportation instruments.

2. The brokering method of claim 1, further comprising:
facilitating the administration of the underlying contracts by brokers or third party logistic providers.

3. The brokering method of claim 1, further comprises trading of said transportation instruments within spot, forward, shorthaul, series or derivative markets.

4. The brokering method of claim 1, wherein said trading step further comprises:
measuring the objective performance of shippers and carriers and using that information in selecting a trade.

5. The brokering method of claim 4, wherein said ratings are used anonymously.

6. The brokering method of claim 1, wherein said trading step further comprises:
evaluating the subjective performance of shippers and carriers and using that information in selecting a trade.

7. The brokering method of claim 6, wherein said ratings are used anonymously.

8. The brokering method of claim 1, further comprising:
maintaining said bids or offers to remain open in the market for a predetermined time period; and automatically removing said bids or offers at the end of that time period.

9. The brokering method of claim 1, further comprising:
maintaining said contingent bids or contingent offers to be open across multiple modes, lanes or markets of transportation,
whereby upon first acceptance at a specific mode, lane or market; removing the remaining contingent bids or contingent offers across all other modes, lanes and markets.

10. The brokering method of claim 1, further comprising:
removing open contingent bids or offers upon achieving an objective performance criterion.

11. The brokering method of claim 1, further comprising:
using a Prioritized Scheduled Push (PSP) for updating one or more links either when a client submits a request to the server or periodically without any direct request from the client.

12. The brokering method of claim 1, further comprising the offer of contingent capacity for a multi-leg or backhaul; and coordinating said multi-leg or backhaul with said shipper(s) and carrier.

13. The brokering method of claim 10, wherein the booking of one leg causes the offer prices of remaining legs to be set to a different value.

14. The brokering method of claim 1, wherein multiple compatible partial loads are combined in booking an offered truck.

15. The brokering method of claim 1, further comprising:
importing and exporting groups of bids or offers from Comma Separated Variable files or equivalents into and from said staging area, thereby
allowing information from said staging area to be administered in a Comma Separated Variable file or spreadsheet format.

16. A method of matching a tendered shipment to offered conveyances, comprising:
receiving into a staging area a tendered shipment;
receiving into said staging area a plurality of dissimilar offers from carriers;
sorting said shipment into a first fuzzy commodity;
sorting and aggregating said carrier offers into a second fuzzy commodity;
selecting one or more offers from the matching sets of said first and second fuzzy commodities in said staging area based upon a set of objective and subjective criteria; and
creating an underlying contract to support said transport of the shipment.

17. A method of matching an offered conveyance to tendered shipments, comprising:
receiving into a staging area an offered conveyance;
receiving into said staging area a plurality of dissimilar tendered shipments;
sorting said offered conveyance into a first fuzzy commodity;
sorting and aggregating said tendered shipments into a second fuzzy commodity;
selecting one or more shipments from the matching sets of said first and second fuzzy commodities in said staging area based upon a set of objective and subjective criteria; and
creating an underlying contract to support said transport of the shipments.

18. A computer system for brokering a plurality of freight-shipments and carrier capacity, comprising:
marketplace means for establishing a bid-ask (offer) marketplace including shipper bids and carrier offers, wherein said bids and offers are measured by mode, market, and lane and optionally accessorial services.

19. The computer system of claim 18, further comprising:
display means for displaying a marketplace summary.

20. The computer system of claim 18, further comprising:
display means for displaying market details in a bid-ask marketplace.

21. The computer system of claim 18, further comprising:
display means for displaying most recent trades and trade volume

22. The computer system of claim 18, further comprising:
acceptance means for enabling a customer to indicate acceptance of bids or offers.

23. The computer system of claim 18, further comprising:
notification means for notifying one or more parties to a transaction.

24. The computer system of claim 18, further comprising:
tracking/tracing means for determining the current location of a specific freight shipment.

25. The computer system of claim 18, further comprising:
alert means for communicating fulfillment problems corresponding to a specific freight shipment.

26. The computer system of claim 18, further comprising:
administration means for mitigating fulfillment problems corresponding to a specific freight shipment.

27. The computer system of claim 18, further comprising:
trading of transportation within spot, forward, shorthaul, series or derivative markets.

28. The computer system of claim 18, further comprising:
maintaining said bids or offers to remain open in the market for a predetermined time period; and automatically removing said bids or offers at the end of that time period.

29. The computer system of claim 18, further comprising:
maintaining said contingent bids or contingent offers to be open across multiple modes, lanes or markets of transportation,
whereby upon first acceptance at a specific mode, lane or market; removing the remaining contingent bids or contingent offers across all other modes, lanes and markets.

30. The computer system of claim 18, further comprising:
removing open contingent bids or offers upon achieving an objective performance criterion.

31. The computer system of claim 18, further comprising:
using a Prioritized Scheduled Push (PSP) for updating one or more links either when a client submits a request to the server or periodically without any direct request from the client.

32. The computer system of claim 18, further comprising the offer of contingent capacity for a multi-leg or backhaul; and coordinating said multi-leg or backhaul with said shipper(s) and carrier.

33. The computer system of claim 32, wherein the booking of one leg causes the offer prices of remaining legs to be set to a different value.

34. The computer system of claim 18, wherein multiple compatible partial loads are combined in booking an offered truck.

35. The computer system of claim 18, further comprising:
importing and exporting groups of bids or offers from Comma Separated Variable files or equivalents into and from said staging area, thereby
allowing information from said staging area to be administered in a Comma Separated Variable file or spreadsheet format.

36. The computer system of claim 18, further comprising a method of matching a tendered shipment to offered conveyances, comprising:
receiving into a staging area a tendered shipment;
receiving into said staging area a plurality of dissimilar offers for transporting goods;
sorting said shipment into a first fuzzy commodity;
sorting and aggregating said carrier offers into a second fuzzy commodity;
selecting one or more offers from the matching sets of said first and second fuzzy commodity in said staging area based upon a set of objective and subjective criteria; and
creating an underlying contract to support said transport of the shipment.

37. The computer system of claim 18, further comprising a method of matching an offered conveyance to tendered shipments, comprising:
receiving into a staging area an offered conveyance;
receiving into said staging area a plurality of dissimilar tendered shipments;
sorting said offered conveyance into a first fuzzy commodity;
sorting and aggregating said tendered shipments into a second fuzzy commodity;
selecting one or more shipments from the matching sets of said first and second fuzzy commodity in said staging area based upon a set of objective and subjective criteria; and
creating an underlying contract to support said transport of the shipments.

38. A computer system for trading transportation futures, comprising:
receiving into a staging area a plurality of dissimilar bids for shipping goods;
receiving into said staging area a plurality of dissimilar offers for transporting goods;
sorting said shipping bids into a set of first futures;
sorting and aggregating said carrier offers into a set of second futures;
selecting matching sets of said first and second futures in said staging area to create a bid-ask marketplace for transportation future instruments; and
creating underlying contracts to support the trading of said transportation future instruments.

39. A computer system for trading transportation options, comprising:
receiving into a staging area a plurality of dissimilar bids for options on shipping goods;
receiving into said staging area a plurality of dissimilar offers on options for transporting goods;
sorting said shipping bids into a set of first options;
sorting and aggregating said carrier offers into a set of second options;
selecting matching sets of said first and second options in said staging area to create a bid-ask marketplace for transportation option instruments; and
creating underlying contracts to support the trading of said transportation option instruments.

40. A computer system for trading transportation options on futures, comprising:
receiving into a staging area a plurality of dissimilar bids for options on futures for shipping goods;
receiving into said staging area a plurality of dissimilar offers on options on futures for transporting goods;
sorting said shipping bids into a set of first options on futures;
sorting and aggregating said carrier offers into a set of second options on futures;
selecting matching sets of said first and second options on futures in said staging area to create a bid-ask marketplace for transportation option on future instruments;
creating underlying contracts to support the trading of said option on futures transportation instruments, and
bi-directional communication links coupled said computer system to the futures and options computer systems to create price consistency and to facilitate inter-market trading to manage risk taken in a position resulting from a trade in either market.

41. A method of calculating a standardized transportation line haul rate per mile, comprising:
receiving into a staging area transportation data for a shipment;
calculating standardized route miles from the zip codes of all stops in transit including origin and final destination and allowable practical routes for the type of cargo transported;
calculating the line haul price from the total price less standardized charges for provided accessorials; and
calculating the standardized line haul rate per mile by dividing the line haul price by the standardized route miles.

42. A computer system for calculating historical market data on transportation, comprising:
means for receiving into a staging area a plurality of completed shipment transportation data, and;
software program to calculate the standardized line haul rate per mile for each completed shipment.

43. The computer system of claim 42, further comprising:
software program to sort and aggregate all shipments by lane, mode, market and date of shipment.

44. The computer system of claim 42, further comprising:
means for receiving into a staging area a plurality of shipment requests and offered capacity transportation data; and
software program to calculate the standardized line haul rate per mile for each tendered shipment or offered capacity.

45. The computer system of claim 42, further comprising:
means for requesting the display of data sorted by lane, mode, market and date(s) of shipment.

46. The computer system of claim 42, further comprising:
display means for displaying the requested data.

47. The computer system of claim 42, further comprising:
output means for transferring the data to another computer system for further use.
